(19) United States
(12) Patent Application Publication
(10) Pub. No.: US 2025/0266957 A1
(43) Pub. Date: Aug. 21, 2025

(54) DIGITAL POST DISTORTION FOR UPLINK

(71) Applicant: QUALCOMM INCORPORATED, San Diego, CA (US)

(72) Inventors: Ram Krips, Ramat Gan (IL); Elad Meir, Ramat Gan (IL); Gideon Shlomo Kutz, Ramat Hasharon (IL); Assaf Touboul, Netanya (IL)

(21) Appl. No.: 18/859,138

(22) PCT Filed: Jun. 7, 2023
(86) PCT No.: PCT/US2023/068076

§ 371 Date: Oct. 22, 2024

(30) Foreign Application Priority Data
Jun. 28, 2022 (IL) 294367

(51) Int. Cl. H04L 5/00

(52) U.S. Cl. CPC H04L 5/0051; H04L 5/0039; H04L 5/0098

(57) ABSTRACT

Methods, systems, and devices for wireless communications are described. A network entity may perform digital post distortion (DPoD) using signals transmitted from multiple user equipments (UEs) on adjacent frequency resources. Each UE may transmit, to the network entity, a data message on a first set of frequency resources and a pilot signal associated with the data message on a set of subcarriers within a second set of frequency resources. The first set of frequency resources may be a subset of the second set of frequency resources. The set of subcarriers includes one of odd or even indexed subcarriers within the second set of frequency resources. A first portion of the set of subcarriers may be within the first set of frequency resources and a second portion of the set of subcarriers may be within the second set of frequency resources and outside the first set of frequency resources.

### CROSS REFERENCES

The present Application is a 371 national stage filing of International PCT Application No. PCT/US2023/068076 by Krips et al. entitled “DIGITAL POST DISTORTION FOR UPLINK,” filed Jun. 7, 2023; and claims priority to Israel Patent Application No. 294367 by Krips et al. entitled “DIGITAL POST DISTORTION FOR UPLINK,” filed Jun. 28, 2022, each of which is assigned to the assignee hereof, and each of which is expressly incorporated by reference in its entirety herein.

### FIELD OF TECHNOLOGY

The following relates to wireless communications, including digital post distortion (DPoD) for uplink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, a communication device (e.g., a network entity, a UE) may support the use of digital post-distortion (DPoD) to compensate for non-linear noise of signals introduced by analog components of another communication device (e.g., a network entity, a UE) from which the signal was transmitted (e.g., a transmitting device). In some cases, existing techniques for DPoD may be deficient.

### SUMMARY

The described techniques relate to improved methods, systems, devices, and apparatuses that support digital post distortion (DPoD) for uplink. For example, the described techniques provide for configuring a user equipment (UE) to transmit pilot signals, such as demodulation reference signals (DMRS), over frequency resources adjacent to (e.g., beyond) frequency resources allocated to the UE for data transmissions (e.g., out-of-band frequencies). In some examples, the UE may transmit a data message on a first set of frequency resources and a pilot signal associated with the data message on a set of subcarriers within a second set of frequency resources. The first set of frequency resources may be a subset of the second set of frequency resources. The set of subcarriers includes one of odd or even indexed subcarriers within the second set of frequency resources. A first portion of the set of subcarriers may be within the first set of frequency resources and a second portion of the set of subcarriers may be within the second set of frequency resources and outside the first set of frequency resources.

A method for wireless communication at a user equipment (UE) is described. The method may include transmitting a data message on a first set of frequency resources and transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

An apparatus for wireless communication at a UE is described. The apparatus may include a processor, and a memory coupled with the processor, wherein the memory comprises instructions executable by the processor to cause the apparatus to transmit a data message on a first set of frequency resources and transmit a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Another apparatus for wireless communication at a UE is described. The apparatus may include means for transmitting a data message on a first set of frequency resources and means for transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

A non-transitory computer-readable medium storing code for wireless communication at a UE is described. The code may include instructions executable by a processor to transmit a data message on a first set of frequency resources and transmit a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Some examples of the method, apparatuses, and non-transitory computer-readable medium described herein may further include operations, features, means, or instructions for receiving, from a network entity, an indication of a set of one or more parameters for the UE to use to determine the pilot signal for the set of subcarriers based at least in part on the data message, where transmitting the pilot signal may be based at least in part on the set of one or more parameters.

Some examples of the method, apparatuses, and non-transitory computer-readable medium described herein may further include operations, features, means, or instructions for receiving, from a network entity, an indication identifying the set of subcarriers for the UE to use to transmit the pilot signal, where transmitting the pilot signal may be based at least in part on the indication identifying the set of subcarriers.

Some examples of the method, apparatuses, and non-transitory computer-readable medium described herein may further include operations, features, means, or instructions for transmitting, to a network entity, a UE capability message indicating a first capability of the UE to transmit the data message for DPoD processing at the network entity, a second capability of the UE to transmit a set of multiple pilot signals distributed across the second set of frequency resources, or a combination thereof, where transmitting the pilot signal outside the first set of frequency resources may be based at least in part on the UE capability message.

Some examples of the method, apparatuses, and non-transitory computer-readable medium described herein may further include operations, features, means, or instructions for receiving, from the network entity and in response to the UE capability message, a configuration message configuring the UE to implement the first capability, the second capability, or a combination thereof, where transmitting the pilot signal may be further based at least in part on the configuration message.

In some examples of the method, apparatuses, and non-transitory computer-readable medium described herein, the set of subcarriers includes all of the one of odd or even indexed subcarriers of the second set of frequency resources.

In some examples of the method, apparatuses, and non-transitory computer-readable medium described herein, the set of subcarriers includes every fourth subcarrier within the second set of frequency resources.

In some examples of the method, apparatuses, and non-transitory computer-readable medium described herein, the first set of frequency resources further includes a second set of subcarriers for a second pilot signal of a second UE that may be associated with a data message of the second UE transmitted on frequency resources outside the first set of frequency resources, and the second set of subcarriers includes a different one of the odd or even indexed subcarriers within a first portion of the first set of frequency resources.

In some examples of the method, apparatuses, and non-transitory computer-readable medium described herein, the first set of frequency resources further includes a third set of subcarriers for a third pilot signal of a third UE that may be associated with a data message of the third UE transmitted on frequency resources outside the first set of frequency resources, and the third set of subcarriers includes the different one of the odd or even indexed subcarriers within a second portion of the first set of frequency resources different than the first portion.

In some examples of the method, apparatuses, and non-transitory computer-readable medium described herein, the first set of frequency resources includes first frequency resources allocated for data communications of the first UE and the method, apparatuses, and non-transitory computer-readable medium may include further operations, features, means, or instructions for determining the second frequency resources based at least in part on an estimated non-linearity characteristic of the data message.

In some examples of the method, apparatuses, and non-transitory computer-readable medium described herein, determining the second frequency resources may include operations, features, means, or instructions for selecting the second frequency resources based at least in part on the estimated non-linearity characteristic of the data message satisfying an interference threshold for the second frequency resources.

In some examples of the method, apparatuses, and non-transitory computer-readable medium described herein, the pilot signal includes a DMRS.

Some examples of the method, apparatuses, and non-transitory computer-readable medium described herein may further include operations, features, means, or instructions for aligning a first amplitude associated with a complementary cumulative distribution function of the pilot signal with a second amplitude associated with the complementary cumulative distribution function of the data message and transmitting the pilot signal based at least in part on the alignment.

In some examples of the method, apparatuses, and non-transitory computer-readable medium described herein, aligning the first amplitude with the second amplitude may include operations, features, means, or instructions for selecting a first portion of resources of a set of resources for transmitting the pilot signal according to a polynomial generation technique and selecting a second portion of resources of the set of resources for transmitting the pilot signal sequentially based at least in part on a difference between the first amplitude associated with the complementary cumulative distribution function of the pilot signal and the second amplitude associated with the complementary cumulative distribution function of the data message, where the pilot signal may be transmitted using the set of resources.

A method for wireless communication at a network entity is described. The method may include receiving, from a UE, a data message on a first set of frequency resources and receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

An apparatus for wireless communication at a network entity is described. The apparatus may include a processor, and a memory coupled with the processor, wherein the memory comprises instructions executable by the processor to cause the apparatus to receive, from a UE, a data message on a first set of frequency resources and receive, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Another apparatus for wireless communication at a network entity is described. The apparatus may include means for receiving, from a UE, a data message on a first set of frequency resources and means for receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

A non-transitory computer-readable medium storing code for wireless communication at a network entity is described. The code may include instructions executable by a processor to receive, from a UE, a data message on a first set of frequency resources and receive, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Some examples of the method, apparatuses, and non-transitory computer-readable medium described herein may further include operations, features, means, or instructions for transmitting, to the UE, an indication of a set of one or more parameters for the UE to use to determine the pilot signal for the set of subcarriers based at least in part on the data message, where receiving the pilot signal may be based at least in part on the set of one or more parameters.

Some examples of the method, apparatuses, and non-transitory computer-readable medium described herein may further include operations, features, means, or instructions for transmitting, to the UE, an indication identifying the set of subcarriers for the UE to use to transmit the pilot signal, where receiving the pilot signal may be based at least in part on the indication identifying the set of subcarriers.

Some examples of the method, apparatuses, and non-transitory computer-readable medium described herein may further include operations, features, means, or instructions for receiving, from the UE, a UE capability message indicating a first capability of the UE to transmit the data message for DPoD processing at the network entity, a second capability of the UE to transmit a set of multiple pilot signals distributed across the second set of frequency resources, or a combination thereof, where receiving the pilot signal may be based at least in part on the UE capability message.

Some examples of the method, apparatuses, and non-transitory computer-readable medium described herein may further include operations, features, means, or instructions for transmitting, to the UE in response to the UE capability message, a configuration message configuring the UE to implement the first capability, the second capability, or a combination thereof, where receiving the pilot signal may be further based at least in part on the configuration message.

In some examples of the method, apparatuses, and non-transitory computer-readable medium described herein, the set of subcarriers includes all of the one of odd or even indexed subcarriers of the second set of frequency resources.

In some examples of the method, apparatuses, and non-transitory computer-readable medium described herein, the set of subcarriers includes every fourth subcarrier within the second set of frequency resources.

Some examples of the method, apparatuses, and non-transitory computer-readable medium described herein may further include operations, features, means, or instructions for receiving, from a second UE, a second data message on a third set of frequency resources, where the third set of frequency resources overlaps at least a portion of the second set of frequency resources and receiving, from the second UE, a second pilot signal associated with the second data message on a second set of subcarriers, where the second set of subcarriers includes a different one of the odd or even indexed subcarriers within the third set of frequency resources, a first portion of the second set of subcarriers may be within the first set of frequency resources, and a second portion of the second set of subcarriers may be within the second set of frequency resources.

Some examples of the method, apparatuses, and non-transitory computer-readable medium described herein may further include operations, features, means, or instructions for receiving, from a third UE, a third data message on a fourth set of frequency resources, where the fourth set of frequency resources overlaps at least a portion of the second set of frequency resources, and may be outside the third set of frequency resources and receiving, from the third UE, a third pilot signal associated with the third data message on a third set of subcarriers, where the third set of subcarriers includes the different one of the odd or even indexed subcarriers within the fourth set of frequency resources, a first portion of the third set of subcarriers may be within the first set of frequency resources, and a second portion of the third set of subcarriers may be within the second set of frequency resources.

In some examples of the method, apparatuses, and non-transitory computer-readable medium described herein, the first set of frequency resources includes first frequency resources allocated for data communications of the first UE and the method, apparatuses, and non-transitory computer-readable medium may include further operations, features, means, or instructions for determining the second frequency resources for the UE based at least in part on an estimated non-linearity characteristic of the data message.

In some examples of the method, apparatuses, and non-transitory computer-readable medium described herein, determining the second frequency resources may include operations, features, means, or instructions for selecting the second frequency resources for the UE based at least in part on the estimated non-linearity characteristic satisfying an interference threshold for the second frequency resources for the UE.

In some examples of the method, apparatuses, and non-transitory computer-readable medium described herein, the signaling associated with the data message includes a non-linearity characteristic and the method, apparatuses, and non-transitory computer-readable medium may include further operations, features, means, or instructions for performing a DPoD technique on the data message and at least one other data message of a second UE and decoding the data message and the at least one other data message based at least in part on performing the DPoD technique.

Some examples of the method, apparatuses, and non-transitory computer-readable medium described herein may further include operations, features, means, or instructions for performing channel estimation based at least in part on the pilot signal associated with the data message and decoding the data message based at least in part on the channel estimation.

In some examples of the method, apparatuses, and non-transitory computer-readable medium described herein, the pilot signal includes a DMRS.

### BRIEF DESCRIPTION OF THE DRAWINGS

FIGS. 1 and 2 each illustrate an example of a wireless communications system that supports digital post distortion (DPoD) for uplink in accordance with one or more aspects of the present disclosure.

FIG. 3A illustrates an example of a pilot signal scheme that supports DPoD for uplink in accordance with one or more aspects of the present disclosure.

FIG. 3B illustrates an example of an out-of-band (OOB) signal interference graph that supports DPoD for uplink in accordance with one or more aspects of the present disclosure.

FIG. 4 illustrates an example of a DPoD processing scheme that supports DPoD for uplink in accordance with one or more aspects of the present disclosure.

FIG. 5 illustrates an example of a block diagram that supports DPoD for uplink in accordance with one or more aspects of the present disclosure.

FIG. 6 illustrates an example of a process flow that supports DPoD for uplink in accordance with one or more aspects of the present disclosure.

FIGS. 7 and 8 show block diagrams of devices that support DPoD for uplink in accordance with one or more aspects of the present disclosure.

FIG. 9 shows a block diagram of a communications manager that supports DPoD for uplink in accordance with one or more aspects of the present disclosure.

FIG. 10 shows a diagram of a system including a device that supports DPoD for uplink in accordance with one or more aspects of the present disclosure.

FIGS. 11 and 12 show block diagrams of devices that support DPoD for uplink in accordance with one or more aspects of the present disclosure.

FIG. 13 shows a block diagram of a communications manager that supports DPoD for uplink in accordance with one or more aspects of the present disclosure.

FIG. 14 shows a diagram of a system including a device that supports DPoD for uplink in accordance with one or more aspects of the present disclosure.

FIGS. 15 through 18 show flowcharts illustrating methods that support DPoD for uplink in accordance with one or more aspects of the present disclosure.

### DETAILED DESCRIPTION

Some wireless communications systems may implement different types of radio frequency (RF) operations at a communications device. For example, a communication device (e.g., a user equipment (UE)) may utilize a power amplifier to increase the power of a signal transmitted to another communication device (e.g., a network entity). In some examples, the power amplifier may be an example of a high-power (e.g., a non-linear) power amplifier, in which a relationship between an input power and an output power of the power amplifier may be non-linear. In some examples, the non-linear relationship between the input power and the output power (e.g., non-linearity of the power amplifier) may negatively impact the transmitted signal. For example, the non-linearity of the power amplifier may distort the signal waveform.

In some examples, to mitigate the effects of non-linearity (or other pre-transmission impairments) due to the non-linearity of the power amplifier, the network entity (e.g., a receiving communication device) may implement digital post-distortion (DPoD) or digital pre-distortion (DPD). Some DPoD techniques may be based at least in part on reference signals (e.g., pilot signals) received from the UE (e.g., a transmitting device). For example, DPoD performed at the network entity may include the use of pilot signals transmitted by the UE for estimating the effects of non-linearity associated with data signals transmitted by the UE. In some examples, such as in the presence of a propagation channel, DPoD (e.g., performed at the network entity) may include non-linear estimation and channel estimation based at least in part on the pilot signals transmitted from the UE.

In some examples, the network entity may support frequency division multiple access (FDMA), in which the network entity may receive signals from multiple UEs concurrently. In some examples, signals transmitted from different UEs on adjacent frequency resources (e.g., using frequency division multiplexing (FDM)) may result in out-of-band (OOB) interference. For example, a signal transmitted by a UE may leak into frequency resource regions located outside of frequency resources allocated to the UE for data transmission (e.g., and into frequency resources allocated to other UEs for data transmission). Some DPoD techniques may not be capable of compensating for OOB interference. For example, some DPoD techniques may rely on signals (e.g., pilot signals) transmitted over frequency resources allocated to a particular UE (e.g., in-band data) and, as such, may not be capable of compensating for non-linear interference (or non-linear distortion) that occurs over frequency resources adjacent to the frequency resources allocated to the UE (e.g., the OOB interference). Therefore, such DPoD techniques may not be suitable for scenarios in which the network entity receives signals from multiple UEs on adjacent frequency resources, such as during FDMA.

Various aspects of the present disclosure relate to techniques for DPoD for uplink, and more specifically to configuring a UE with an extended frequency resource allocation for transmitting pilot signals. For example, the network entity may configure the UE to transmit pilot signals, such as demodulation reference signals (DMRS), over frequency resources adjacent to (e.g., beyond) the frequency resources allocated to the UE for data transmissions (e.g., out-of-band frequencies) and frequency resource allocated to the UE for data transmissions. In some examples, the network entity may configure the UE to transmit pilot signals on either even or odd subcarriers within the extended frequency resources allocation.

For example, the network entity may configure the UE to transmit pilot signals on even subcarriers included in the frequency resources allocated to the UE for data transmissions (e.g., frequency resources that are in-band for the UE) as well as even subcarriers included in frequency resources adjacent to the in-band frequency resources (e.g., frequency resources that are OOB for the UE). In such an example, if another UE (e.g., an adjacent UE) has in-band frequency resources which include frequency resources that are OOB for the UE, the other UE may be configured (e.g., by the network entity) to transmit pilot signals over odd subcarriers. In some examples, by configuring two adjacent UEs (e.g., two UEs with adjacent in-band frequency resource allocations) with even and odd subcarriers, the network entity may preserve orthogonality and reduce the likelihood of interference between pilot signals transmitted from the two adjacent UEs. Additionally, or alternatively, the network entity may perform DPoD on the pilot signal transmitted by the UE over the in-band frequency resources and the OOB frequency resources. As such, the network entity may compensate for OOB non-linear distortions (e.g., OOB interference) while maintaining orthogonality between adjacent UEs.

Aspects of the disclosure are initially described in the context of wireless communications systems. Aspects of the disclosure are also described in the context of a pilot signal scheme, an OOB signal interference graph, a DPoD processing scheme, and a block diagram. Aspects of the disclosure are further illustrated by and described with reference to apparatus diagrams, system diagrams, and flowcharts that relate to DPoD for uplink.

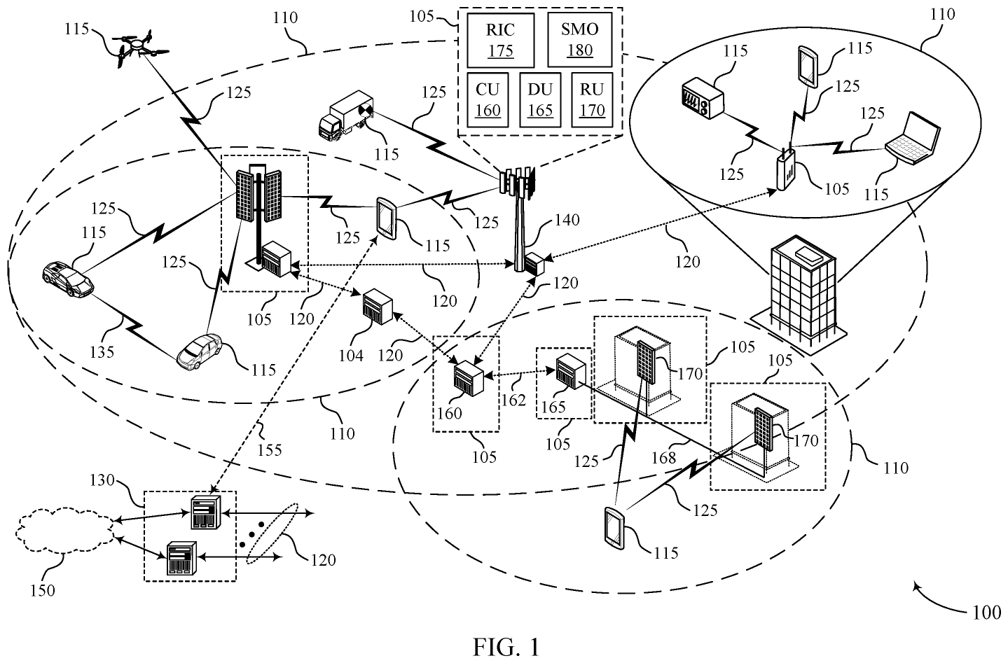

FIG. 1 illustrates an example of a wireless communications system 100 that supports DPoD for uplink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support DPoD for uplink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based at least in part on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, a network entity 105 may configure a UE 115 to transmit pilot signals, such as DMRS, over frequency resources adjacent to (e.g., beyond) frequency resources allocated to the UE 115 for data transmissions (e.g., OOB frequency resources). For example, the UE 115 may transmit a data message on a first set of frequency resources and a pilot signal associated with the data message on a set of subcarriers within a second set of frequency resources. The first set of frequency resources may be a subset of the second set of frequency resources. The set of subcarriers includes one of odd or even indexed subcarriers within the second set of frequency resources. A first portion of the set of subcarriers may be within the first set of frequency resources and a second portion of the set of subcarriers may be within the second set of frequency resources and outside the first set of frequency resources. In some examples, by transmitting pilot signals over OOB frequency resources, the UE 115 may provide one or more enhancements to DPoD performed at the network entity 105, among other possible benefits.

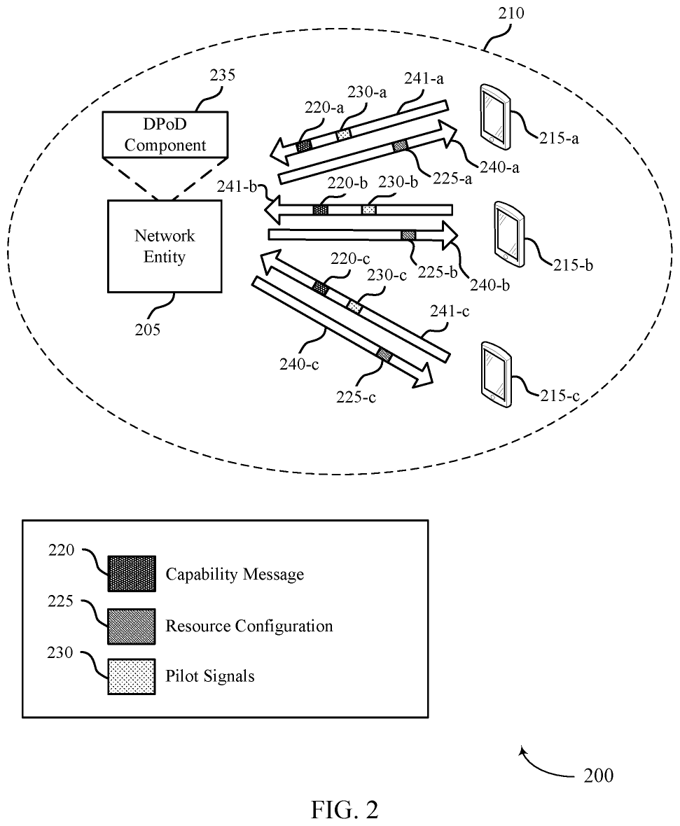

FIG. 2 illustrates an example of a wireless communications system 200 that supports DPoD for uplink in accordance with one or more aspects of the present disclosure. In some examples, the wireless communications system 200 may implement aspects of the wireless communications system 100. For example, the wireless communications system 200 may include a UE 215-a, a UE 215-b, a UE 215-c, and a network entity 205, which may be examples of the corresponding devices as described with reference to FIG. 1. The network entity 205 may operate within a coverage area 210. The coverage area 210 may be an example of a coverage area 110 as described with reference to FIG. 1. The UEs 215 may each communicate with the network entity 205 via one or more communication links. For example, the UE 215-a, the UE 215-b, and the UE 215-c may receive downlink communications from the network entity 205 via a downlink 240-a, a downlink 240-b, and a downlink 240-c, respectively. Additionally, or alternatively, the UE 215-a, the UE 215-b, and the UE 215-c may transmit uplink communications to the network entity 205 via an uplink 241-a, an uplink 241-b, and an uplink 241-c, respectively. In some examples, the downlinks 240 and the uplinks 241 may each be an example of a communication link 125 as described with reference to FIG. 1.

In some examples, a communications device may implement DPoD processing to compensate for non-linearities of a signal (e.g., non-linear distortions of a signal due to non-linearities of a transmit chain used for generating the signal). For example, DPoD may be implemented at a receiving device to compensate for non-linearities of a transmit chain at a transmitting device. In some examples, non-linearities of the transmit chain at the transmitting device may occur at (e.g., result from) a power amplifier (e.g., at the transmitting device). For example, the wireless communications system 200 may support processing of a message for data transmission which may result in a signal with non-linear characteristics. For uplink signaling, a UE 215 (e.g., the UE 215-a, the UE 215-b, or the UE 215-c) may be an example of a transmitting device and the network entity 205 may be an example of a receiving device. Alternatively or additionally, for downlink signaling, the network entity 205 may be an example of a transmitting device and the UE 215 may be an example of a receiving device. In some examples, a transmitting device may utilize one or more components, such as a power amplifier (e.g., a high-power power amplifier, a non-linear power amplifier), to increase the power of a signal transmitted by the UE 215. In some examples, however, power amplifiers may be inherently non-linear. For example, a relationship between an input power to the power amplifier and an output power from the power amplifier may not be linear. In some examples, such non-linearity may negatively impact (e.g., distort) the transmitted signal. For example, the effects of non-linearity may cause channel interference and signal distortion, that may lead to an increased bit-error rate (BER) and, correspondingly, reduced channel reliability and data throughput for the wireless communications system 200.

In some examples, the wireless communications system 200 may employ linearization techniques to mitigate the effects of non-linearity. For example, a communication device of the wireless communications system 200 (e.g., the network entity 205) may employ DPD processing, DPoD processing, or a combination thereof. In some examples, DPD processing and DPoD processing may include estimating the effects of non-linearity (e.g., distortion) and applying the estimations to a signal to mitigate the distortions. To estimate the effects of non-linearity in the presence of a propagation channel (e.g., in which the non-linear signal or one more other signals are transmitted), DPD processing and DPoD processing may include channel estimation.

In some examples, DPD processing (e.g., DPD operations) may occur at a transmitting device, whereas DPoD processing (e.g., DPoD operations) may occur at a receiving device. For example, a UE 215 (e.g., the UE 215-a, the UE 215-b, or the UE 215-c) may transmit one or more pilot signals 230 (e.g., reference signals, DMRSs, sounding reference signals (SRSs)) to the network entity 205 and, in response, the network entity 205 may transmit feedback regarding the one or more pilot signals 230 (e.g., in an over-the-air DPD procedure). In some examples, based at least in part on the feedback, the UE 215 may perform DPD operations to mitigate the effects of non-linearity of a data message (e.g., a data signal) prior to transmitting the data message to the network entity 205. As described herein, a data message may be any transmitted message carrying information, such as a physical uplink shared channel (PUSCH) message, a physical uplink control channel message (PUCCH), or any other type of message. Additionally, or alternatively, DPoD operations may take place at a receiving device. For example, for uplink signaling, the UE 215 may transmit a data message along with pilot signals 230 to the network entity 205, and the network entity 205 may perform DPoD operations based at least in part on the pilot signals 230 (e.g., to mitigate the effects of non-linearity on the received data message).

Additionally, or alternatively, DPD operations may result in an increased constraint on the transmit power (e.g., may reduce a maximum transmit power or an otherwise suitable transmit power achieved by the power amplifier) compared to DPoD operations (e.g., due to the effects of non-linearity being compensated for prior to transmission of the data message). As such, DPoD may enable the transmitting device (e.g., one or more of the UEs 215) to transmit signals with an increased power and operate with increased compression of the power amplifier (e.g., with a relatively more compressed power amplifier operating point). Accordingly, a power efficiency of the power amplifier may be improved, thereby improving a link budget for wireless communications between one or more of the UEs 215 and the network entity 205.

In some examples of the wireless communications system 200, the network entity 205 may implement DPoD processing to facilitate a reduction in overhead associated with processing signals from one or more of the UEs 215. In some examples, such a reduction in signal processing overhead may including transferring some signal processing overhead from one or more of the UEs 215 to the network entity 205. For example, to reduce the processing overhead (e.g., at the UE 215), DPoD operations may be used by the network entity 205 for uplink signaling, while DPD operations may not be used (e.g., by the UE 215). That is, DPD operations at a transmitting device (e.g., the UE 215) may include additional processing and performing DPoD processing at the receiving device (e.g., without DPD) may transfer (e.g., enable) a portion of the processing performed at the transmitting device (e.g., as part of the DPD operations) to the receiving device (e.g., as part of the DPoD operations). Therefore, to reduce the processing overhead at UEs 215, the network entity 205 may perform DPD for downlink transmissions, or DPoD for uplink transmissions, or both, thereby reducing signal processing overhead and battery consumption associated with uplink transmissions at the UEs 215. In some examples, DPoD processing at the network entity 205 may involve analyzing reference signals (e.g., pilot signals) to estimate non-liner distortions of a signal (e.g., the effects of non-linearities of a power amplifier at the transmitting device on the signal). Additionally or alternative, in the presence of a propagation channel (e.g., for communications by neighboring UE 215), DPoD processing may involve analyzing the pilot signals for channel estimation.

In some examples, however, an inherent constraint of the DPoD processing may include the transmission of out-of-band (OOB) emissions due to the increased power amplifier compression. For example, if two (or more) of the UEs 215 are using adjacent frequency allocations for uplink transmissions, OOB emissions from a UE 215 (e.g., the UE 215-a) may interfere with a received signal (e.g., at the network entity 205) from one or more neighboring UEs 215 (e.g., the UE 215-b, the UE 215-c, or both). Such interference may be referred to as OOB inference. In such an example, applying DPoD to each UE 215 (e.g., separately) may lead to reduced (e.g., relatively poor) performance. Moreover, some structures for transmitting reference signals (e.g., a DMRS structure, a pilot signal structure) may not enable the network entity 205 to correct for (e.g., may not enable effective removal of) such interference. For example, some structures for transmitting reference signals may not enable an estimation of OOB interference (or removal of OOB interference) due to a frequency coverage of reference signals (e.g., pilot signals) transmitted from each UE 215 being confined to frequency resources allocated to the respective UEs 215 (e.g., for data transmissions). For example, the UE 215-a may be configured to transmit pilot signals over resources allocated to the UE 215-a (e.g., for data transmission) and, as such, may not transmit pilot signals over frequency resources in which OOB interference occurs (e.g., adjacent frequency resources, frequency resources allocated to the UE 215-b or the UE 215-c). As such, the network entity may not be capable of estimating or removing the OOB interference. Moreover, a peak to average power ratio (PAPR) of pilot signals may be reduced compared to a PAPR of data signals. In some examples, a difference between the PAPR of the pilot signals and the PAPR of the data signals may lead to a decrease in the reliability of non-linear models used for performing channel estimation.

As an illustrative example, the network entity 205 may be an example of a receiving device using a DPoD component 235 and the UEs 215 may each be an example of transmitting devices (e.g., may each transmit uplink signaling to the network entity 205). In some examples, one or more of the UEs 215 may be configured with a component carrier (CC) to use for communications with the network entity 205. For example, the UE 215-a may be configured with a first CC, the UE 215-b may be configured with a second CC, and the UE 215-c may be configured with a third CC. In some examples, the first CC, the second CC, and the third CC may be different (e.g., span different frequencies). In other examples, the first CC, the second CC, and the third CC may overlap (e.g., share at least a portion of frequencies).

For example, the UE 215-a may transmit a data message and pilot signals 230 to the network entity 205 via the first CC. As such, the network entity 205 may receive pilot signals 230 via the first CC from the UE 215-a and perform in-band channel estimation. That is, the network entity 205 may acquire channel knowledge associated with in-band frequency resources. In some examples, in-band frequency resources for each UE 215 may refer to frequency resources allocated for data communications by the respective UE 215. For example, the in-band frequency resources may refer to a carrier bandwidth or a subset of frequency resources in a carrier bandwidth allocated for transmitting a data message. In some examples, transmitting the data message in-band without performing DPD at the UE 215-a may cause the signal indicating the data message to leak into OOB frequency resources (e.g., due to non-linearity characteristics of the signal). In some examples, OOB resources for each UE 215 may refer to resources unallocated for data communications by the respective UE 215. For example, the OOB resources may refer to resources in other carrier bandwidths or resources in the same carrier bandwidth as the in-band frequency resources, but not allocated for transmitting the data message.

For example, the UE 215-a may transmit the signal associated with the data message to the network entity 205 via the first CC, and the network entity 205 may receive the data message on the first CC. In some examples, the signal may leak into CCs allocated to different UEs 215. For example, the signal may leak into at least a portion of resources located within the second CC allocated to the UE 215-b. Because the network entity 205 receives pilot signals 230-a from the UE 215-a via in-band frequency resources (e.g., in the first CC), the network entity 205 may acquire channel knowledge of the in-band frequency resources. However, if the network entity 205 does not receive the pilot signals 230-a in the affected OOB frequency resources, the network entity 205 may fail to mitigate OOB interference, thereby reducing the reliability of successfully receiving data messages from the UE 215-b or the UE 215-c in the OOB frequency resources. Some DPoD techniques which rely on (e.g., rely only on) in-band data may not be suitable for FDM users. For example, such techniques may experience (e.g., suffer from) OOB distortions that may lead to a deteriorated error vector magnitude which may be comparable to (e.g., match or substantially match) a residual interference level. Therefore, OOB inter-UE interference estimation and cancellation may provide one or more efficiencies for such DPoD techniques. For example, DPoD techniques that provide for OOB inter-UE interference estimation and cancellation may provide for non-linear distortions in signals to be removed, such that signal noise may approach thermal noise levels.

In some examples, techniques for DPoD for uplink, as described herein, may provide one or more enhancements to structures for transmitting reference signals (e.g., a DMRS structure, a pilot signal structure). For example, such techniques for DPoD may provide for pilot signal structures that enable estimation and removal of interference between neighboring UEs 215 (e.g., interference between uplink transmissions from neighboring UEs 215). Techniques for DPoD for uplink, as described herein, may provide for a modified pilot signal structure (e.g., DMRS structure) that enables removal of nonlinearity interference between adjacent UEs. In some examples, such techniques may enable complementary cumulative distribution function (CCDF) matching between pilot signals and data signals which may provide one or more benefits to pilot signal formations (e.g., at the UEs 215). For example, by employing the techniques for DPoD for uplink, as described herein, the network entity 205 may estimate the non-linearity experienced by each UE 215, for example by controlling a pilot signal PAPR for each UE 215 (i.e., by controlling an amplitude of the CCDF of pilot signals transmitted by each UE 215). In some examples, technique for controlling the amplitude of the CCDF of the pilot signal may be implemented at the network entity 205 after estimating (e.g., by the network entity 205) the CCDF of data signals transmitted by a UE (e.g., one or more of the UEs 215). In such examples, the network entity 205 may signal (e.g., pre-signal) to the UE to use one or more CCDF amplitude matching techniques. Additionally, or alternatively, the network entity 205 may indicate, to the UE, a PAPR or one or more other CCDF characteristic that may define the pilot signal to be used by the UE (e.g., based on the uplink communication characteristics).

In some examples, techniques for DPoD for uplink (e.g., a modified DPoD method), as described herein, may provide for estimating and compensating for nonlinearity in OFDMA uplink signals with FDM users (e.g., UEs 215 that are performing FDM). Additionally, or alternatively, techniques for DPoD for uplink, as described herein, may provide for a DPoD receiver that enables recovery of signal reception performance for OFDMA, for example by considering (e.g., accounting for) an interference between adjacent frequency allocations (e.g., using one or more of the pilot structures). That is, such techniques for DPoD for uplink may provide for a modified pilot signal structure (e.g., DMRS structure) that enables removal of nonlinearity interference between adjacent UEs.

For example, to support DPoD processing at the network entity 205, the UEs 215 (e.g., the UE 215-a, the UE 215-b, and the UE 215-c) may each implement pilot signaling over frequency resources allocated to the respective UE 215 for transmitting data signals (e.g., in-band frequency resources) and over frequency resources unallocated to the respective UE 215 for data signals (e.g., out-of-band (OOB) frequency resources).

In some examples, the wireless communications system 200 may support OOB pilot signals (e.g., the pilot signals 230) during DPoD operations. For example, the UE 215-a may transmit the pilot signals 230-a distributed across in-band frequency resources and a set of OOB frequency resources. That is, the UE 215-a may transmit DMRSs in in-band frequency resources and OOB frequency resources with a data message transmitted in the in-band frequency resources. For example, the UE 215-a may transmit DMRSs in a different set of resources (e.g., a relatively wider frequency band) than the corresponding uplink signal (e.g., an uplink data signal, an uplink control signal, an uplink feedback signal, etc.). Additionally, or alternatively, the UE 215-a may transmit SRSs in the in-band and OOB resources based at least in part on a resource configuration for the UE 215-a. That is, the UE 215-a may transmit SRSs in a different set of resources (e.g., a relatively wider frequency band) than a configured set of resources for uplink transmissions (e.g., an active uplink BWP, an active uplink resource bandwidth, or any other configured set of uplink frequency resources). The network entity 205, including a DPoD component 235, may perform OOB channel estimation to estimate the effects of non-linearity using OOB pilot signals (e.g., the pilot signals 230).

In some examples, one or multiple of the UEs 215 may transmit capability messages 220 to the network entity 205. For example, the UE 215-a may transmit a capability message 220-a, the UE 215-b may transmit a capability message 220-b, and the UE 215-c may transmit a capability message 220-c to the network entity 205. In some examples, the capability messages 220 may each indicate to the network entity 205 one or more types of non-linearity supported at the corresponding UE 215. For example, the network entity 205 may determine (e.g., based on the capability message 220 or transmissions performed at the corresponding UE 215) that the corresponding UE 215 may transmit distorted data with relatively high or relatively low non-linearities (e.g., compared to a range of non-linearities associated with signals transmitted at the UEs 215). In some examples, the network entity 205 may determine the frequency span of the pilot signals for a UE based on determining the type of non-linearity supported at the UE 215 (e.g., by defining non-linearity options using one or more parameters or tables). In some examples, a data message for which associated signaling is non-linear may be referred to as a compressed data message. For example, such information may be indicated in one or more information elements (IEs) included in a UE capability message. In some examples, the UE capability message may be an example of an RRC message. In some examples, the UE 215-a, the UE 215-b, and the UE 215-c may indicate to the network entity 205 power thresholds for which the UE 215-a, the UE 215-b, and the UE 215-c may transmit linear or non-linear signals for data messages.

In some examples, the network entity 205 may transmit resource configurations 225 (e.g., a resource configuration 225-a, a resource configuration 225-b, and a resource configuration 225-c) to the UEs 215. A resource configuration (e.g., one or multiple of the resource configurations 225) may indicate a relatively wider frequency band (e.g., an extended frequency resource allocation) for the UEs 215 to use for pilot signaling than for data signaling. In some examples, the relatively wider frequency band may be based at least in part on in-band frequencies (e.g., assigned resources, CCs). For example, the network entity 205 may indicate a frequency span in which a UE (e.g., one or multiple of the UEs 215) may extend assigned in-band frequency resources for pilot signaling. Additionally, or alternatively, the relatively wider frequency band may be based at least in part on non-linear characteristics of a message. The non-linear characteristics may be estimated or defined at the network entity 205, for example using one or more parameters, rules, or tables, or any combination thereof. In some examples (e.g., in accordance with the parameters, rules, or tables), the non-linear characteristics of the message may not exceed a threshold that is based on frequencies of the frequency band (e.g., a frequency distance). For example, the network entity 205, the UEs 215, or both may estimate (or determine based on the parameters, rules, or tables) a set of OOB frequency resources which may be significantly affected (e.g., experience interference above a pre-configured, semi-static, or dynamic interference threshold) by a non-linear signal transmitted in in-band frequency resources. In some examples, the network entity 205 may transmit the resource configuration 225-a to the UE 215-a, and the UE 215-a may extend pilot resources to include the first CC and at least a portion of the second CC (e.g., where non-linearity is expected). Similarly, the network entity 205 may transmit the resource configuration 225-b to the UE 215-b, and the UE 215-b may extend pilot resources to include the second CC and at least a portion of the first CC and a portion of the third CC (e.g., where non-linearity is expected). Similarly, the network entity 205 may transmit the resource configuration 225-c to the UE 215-c, and the UE 215-c may extend pilot resources to include the third CC and at least a portion of the second CC (e.g., where non-linearity is expected). In some examples, the resource configurations 225 may be signaled to the UEs 215 via RRC signaling, downlink control information (DCI) signaling, or a combination thereof.

In some examples, the network entity 205 may receive in-band and OOB pilot signals from UEs 215 and may perform DPoD. For example, the UE 215-a may transmit a data message on a first set of frequency resources and a pilot signal (e.g., one or more pilot signals 230-a) associated with the data message on a set of subcarriers within a second set of frequency resources. The first set of frequency resources may be a subset of the second set of frequency resources. The set of subcarriers includes one of odd or even indexed subcarriers within the second set of frequency resources. A first portion of the set of subcarriers may be within the first set of frequency resources and a second portion of the set of subcarriers may be within the second set of frequency resources and outside the first set of frequency resources. That is, the UE 215-a may transmit the pilot signals 230-a on frequency resources located within the first CC and at least a portion of the second CC. The UE 215-b may transmit pilot signals 230-b on frequency resources located within the second CC as well as resources located within at least a portion of the first CC and at least a portion of the third CC. The UE 215-c may transmit the pilot signal 230-c on frequency resources located within the third CC and at least a portion of the second CC.

In some examples, based at least in part on the received pilot signals 230, the network entity 205 may estimate the effects of non-linearity using a DPoD component 235. For example, the network entity 205 may perform channel estimation using OOB pilot signals (e.g., the pilot signals 230-a) in the portion of the second CC to mitigate interference from a first data message received from the UE 215-a in the first CC on a second data message received from the UE 215-b in the second CC. Similarly, the network entity 205 may perform channel estimation using OOB pilot signals (e.g., the pilot signals 230-b in the portion of the first CC to mitigate interference from the second data message received from the UE 215-b in the second CC on the first data message received from the UE 215-a in the first CC. In this way, the OOB pilot signaling may increase the reliability of communications, throughput, and performance of the UEs 215 in a multi-UE systems (e.g., systems implementing multi-user multiple input, multiple output (MU-MIMO) on the uplink) in the presence of non-linear signal transmissions. DPoD techniques for uplink, as described herein may provide improvements to DPoD performance, for example by enabling interference cancellation between adjacent UEs 215. Additionally, or alternatively, such DPoD techniques may provide improved estimation of uplink signal nonlinearity, for example by enabling the UEs 215 to use reference signals (e.g., DMRSs, SRSs) that may have a PAPR comparable to that of the data PAPR.

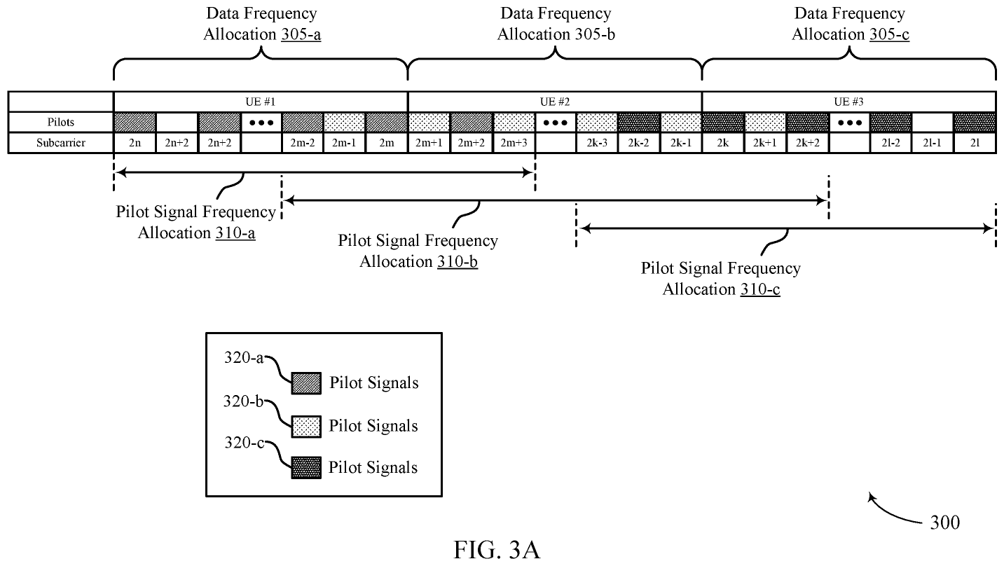

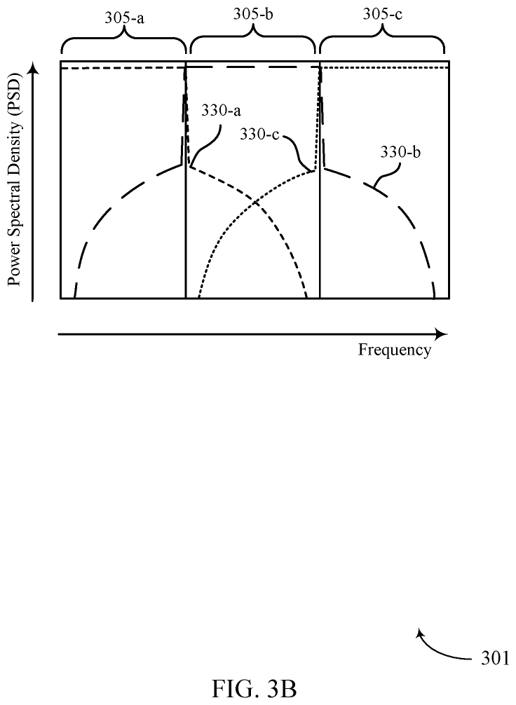

FIG. 3A illustrates an example of a pilot signal scheme 300 that supports DPoD for uplink in accordance with one or more aspects of the present disclosure. In some examples, the pilot signal scheme 300 may implement or be implemented by aspects of the wireless communications system 100 and the wireless communications system 200. For example, the pilot signal scheme 300 may be implemented by a UE or a network entity, which may be examples of the corresponding devices as described with reference to FIGS. 1 and 2.

In some examples, the network entity may communicate with multiple UEs (e.g., a UE #1, a UE #2, and a UE #3). For uplink transmissions, the network entity may be an example of a receiving device and the UE #1, the UE #2, and the UE #3 may be examples of transmitting devices. In some examples, each UE may be configured with a subset of resources (e.g., frequency resources) to be used by the UE for transmitting data. For example, the UE #1, the UE #2, and the UE #3 may each be configured with a data frequency allocation 305. As illustrated in the example of FIG. 3A, a first user (e.g., the UE #1) may be configured with a data frequency allocation 305-a, in which the UE #1 may transmit data signals or the pilot signals 320-a (or both) over a subset of frequencies that may include subcarriers 2n through 2m (e.g., in which n and m may each be integers). Additionally, or alternatively, the UE #1 may transmit pilot signals over other frequencies (e.g., frequency resources) adjacent to (e.g., neighboring) the data frequency allocation 305-a. That is, the UE #1 may transmit pilot signals over in band frequencies (e.g., frequencies included in the data frequency allocation 305-a) and over OOB frequencies (e.g., the frequencies adjacent to the data frequency allocation 305-a).

For example, the UE #1 may be configured with a pilot signal frequency allocation 310-a for transmitting pilot signals 320-a. In some examples, the pilot signal frequency allocation 310-a may include subcarriers 2n through 2m+3. In some examples, pilot signals transmitted by the UE #1 may span some frequencies allocated to a neighboring user (e.g., the UE #2). For example, the UE #2 may be configured with a data frequency allocation 305-b, in which the UE #2 may transmit data signals or the pilot signals 320-b (or both) over a subset of frequencies that may include subcarriers 2m+1 through 2k−1 (e.g., in which k may be an integer). As such, pilot signals transmitted by the UE #1 may span some frequencies (e.g., frequencies including 2m+1 through 2m+3, frequencies that are OOB for the UE #1) allocated to the UE #2 (e.g., for transmitting data). In some examples, by transmitting pilot signals 320-a over some frequencies allocated to an a neighboring user, the UE #1 may enable channel estimation (e.g., at the network) of the channel experienced by the OOB emissions of the UE #1 on the allocation (e.g., a data frequency allocation 305-b) of the UE #2 and enable its cancellation from the UE #2 frequencies.

Additionally, or alternatively, the second user (e.g., the UE #2) may be configured with a pilot signal frequency allocation 310-b for transmitting pilot signals 320-b. In some examples, the pilot signal frequency allocation 310-b may include subcarriers 2m−2 through 2k+2. In such an example, the pilot signals 320-b transmitted by the UE #2 may span some frequencies allocated to neighboring users (e.g., the UE #1 and the UE #3). That is, the pilot signals 320-b may cover a portion of frequencies allocated to the UE #1 (e.g., frequencies including subcarriers 2m−2 through 2m). Additionally, or alternatively, the UE #3 may be configured with a data frequency allocation 305-c, in which the UE #3 may transmit data or pilot signals 320-c (or both) over a subset of frequencies that may include subcarriers 2k through 2/(e.g., in which/may be an integer). As such, the pilot signals 320-b may cover a portion of frequencies allocated to the UE #3 (e.g., frequencies including subcarriers 2k through 2k+2). In some examples, by transmitting pilot signals 320-b over some frequencies allocated to neighboring users (e.g., the UE #1 and the UE #3), the UE #2 may enable channel estimation of (e.g., at the network) of the channel experienced by the OOB emissions of the UE #2 on the allocation (e.g., a data frequency allocation 305-b) of the UE #2 and enable its cancellation (removal of nonlinear distortions) from the UE #1 and the UE #3 frequencies. That is, for two UEs with adjacent data frequency allocations (e.g., adjacent data frequency allocations 305), pilot signal frequency allocation (e.g., pilot signal frequency allocations 310) in accordance with the pilot signal scheme 300, may cover OOB interference for both UEs. As such, pilot signal frequency allocations 310 (e.g., the pilot signal frequency allocation 310-a, the pilot signal frequency allocation 310-b, and a pilot signal frequency allocation 310-c) may cover a frequency span of mutual interference. In some examples, if a UE is allocated frequencies that exceed a threshold (e.g., exceed about 50 MHz) and an adjacent UE is allocated frequencies that fail to exceed the threshold the UEs may be allocated a number of resources (e.g., a maximum number of resources or an otherwise suitable number of resources) for transmitting pilot signals in accordance with the pilot signal scheme 300.

In some examples, the UE #1 and the UE #3 may be configured to transmit on even subcarriers (e.g., to use even resource elements), for example starting at subcarrier 2n for the UE #1 and subcarrier 2k for the UE #3 Additionally, or alternatively, the UE #2 may be configured to transmit on odd subcarriers (e.g., to use odd resource elements), for example, starting at subcarrier 2m+1. In some examples, by configuring a UE (e.g., the UE #2) to transmit pilot signals over odd subcarriers and neighboring UEs (e.g., the UE #1 and the UE #3) to transmit pilot signals over even subcarriers, the network entity may maintain (e.g., preserve) orthogonality under non-linearity as the even resource elements (e.g., signals transmitted over the even subcarriers) may interfere with even resource elements and odd resource elements may interfere with odd resource elements (e.g., due to power amplifier compression).

In some examples, even resource elements may interfere with even resource elements (e.g., and odd resource elements may interference with odd resource elements) due to characteristics of signal harmonics. For example, even signal harmonics may be allocated relatively far (e.g., in frequency) compared to odd signal harmonics. That is, odd signal harmonics that may occur over frequencies that are in-band for a UE (e.g., the UE #2) may interfere with other odd signal harmonics in-band (e.g., allocated) for the UE #2 or other (e.g., neighboring) odd signal harmonics unallocated (e.g., OOB) for the UE #2. Therefore, selecting (e.g., attentively) even and odd resource elements for adjacent UEs may preserve orthogonality and enable channel estimation (e.g., at the network) with reduced interference (e.g., interference free channel estimation). For example, the network entity may use the pilot signals 320 (e.g., received from the UE #1, the UE #2, and the UE #3) to estimate the channel for in-band and OOB resources for each of the UE #1, the UE #2, and the UE #3 during DPoD operations.

In some examples, to support MIMO (e.g., and other scenarios in which extended pilots overlap), some other structures for allocating subcarriers to neighboring UEs (e.g., structures other than allocating even and odd subcarriers to neighboring UEs) may be used (e.g., configured by the network entity). For example, neighboring UEs may use (e.g., be configured to use) a comb of a particular modulus (e.g., of about 4), among other examples. In some examples, however, some configurations (e.g., structures) may include joint channel estimation (e.g., and power amplifier model estimation) due to unmaintained (e.g., lost) orthogonality between neighboring UEs (e.g., due to non-linear distortions between neighboring UEs).

FIG. 3B illustrates an example of an OOB signal interference graph 301 that supports DPoD for uplink in accordance with one or more aspects of the present disclosure. In some examples, the OOB signal interference graph 301 may implement or be implemented by aspects of the wireless communications system 100 and the wireless communications system 200. For example, the OOB signal interference graph 301 may be implemented by a UE or a network entity, which may be examples of the corresponding devices as described with reference to FIGS. 1 and 2.

In some examples, a network entity may communicate with multiple UEs (e.g., the UE #1, the UE #2, and the UE #3) as described with reference to FIG. 3A. In some examples (e.g., without DPD operations performed at the UEs), data messages transmitted from the UE #1, the UE #2, and the UE #3 to the network entity may leak into OOB frequencies due to non-linear signal characteristics (e.g., the non-linear distortions between neighboring UEs). For example, the UE #1 may be configured with the data frequency allocation 305-a, the UE 2 may be configured with the data frequency allocation 305-b, and the UE 3 may be configured with the data frequency allocation 305-c, which may be examples of the corresponding data frequency allocations as described with reference to FIG. 3A. As such, the data frequency allocations for neighboring UEs may be interlaced for multi-user uplink. In some examples, the UE #1 may transmit a data signal over the data frequency allocation 305-a, which, due to non-linearity, may leak into frequency resources located within the data frequency allocation 305-b. For example, a power spectral density (PSD), such as a PSD 330-a associated with a data signal transmitted by the UE #1, may be non-zero (e.g., a non-negligible value) in portions of the data frequency allocation 305-b. Similarly a PSD 330-b for a data signal transmitted by the UE #2 may leak into the data frequency allocation 305-a and the data frequency allocation 305-c, and the PSD 330-c associated with a data signal transmitted by the UE #3 may leak into the data frequency allocation 305-b.

To mitigate the effects of channel interference due to OOB PSDs (e.g., of the PSDs 330), the UE #1, the UE #2, and the UE #3 may be configured to transmit pilot signals on OOB frequencies as described with reference to FIGS. 1, 2, and 3A. That is, the UE #1 may transmit pilot signals to the network on resources within the data frequency allocation 305-a as well as resources within the data frequency allocation 305-b. In some examples, the resources within the data frequency allocation 305-b for pilot signaling from the UE #1 may be based at least in part on a configured frequency buffer around in-band resources of the UE #1. For example, the UE #1 may determine edges of the in-band bandwidth (e.g., of the data frequency allocation 305-a) and may transmit pilot signaling in a number of OOB frequency resources that may extended onto each edge of the in-band bandwidth. Additionally, or alternatively, the UE #1, the network, or both, may determine the resources within the data frequency allocation 305-b for pilot signaling from the UE #1 based at least in part on an estimation of which resources may be affected by the non-linearity of the data signal from the UE #1. For example, the UE #1 may transmit pilot signaling in OOB frequency resources in which the PSD 330-a (or an estimated PSD 330-a) may satisfy (e.g., exceed) a threshold PSD value. Additionally, or alternatively, the UE #1, the network, or both, may determine resources within the data frequency allocation 305-b for the pilot signaling from UE #1 based at least in part on other UE resource allocations. For example, if the OOB resources which may be affected by data signaling from the UE #1 are not allocated for another UE (e.g., the UE #2 or the UE #3), the UE #1 may refrain from transmitting pilot signals in these OOB resources. However, if the OOB resources which may be affected by data signaling from the UE #1 are allocated for another UE (e.g., the UE #2 or the UE #3), the UE #1 may be configured to transmit pilot signaling in the OOB resources.

In some examples, the UE #2 may transmit pilot signals to the network in resources within the data frequency allocation 305-b as well as resources within the data frequency allocation 305-a and the data frequency allocation 305-c. Additionally, or alternatively, the UE #3 may transmit pilot signals to the network in resources located within the data frequency allocation 305-c as well as resources within the data frequency allocation 305-b. As such, the network entity may estimate the channel associated with the in-band and OOB regions (e.g., where the signals may have leaked) and, accordingly, may increase an accuracy at which the network entity may estimate the effects of non-linearity via DPoD processing. For example, to receive and decode (e.g., successfully) a data signal received from the UE #2 in the data frequency allocation 305-b, the network entity may use pilot signaling from the UE #1 to mitigate the OOB PSD 330-a from data signaling from the UE #1 in the data frequency allocation 305-a and may use pilot signaling from the UE #2 to mitigate the OOB PSD 330-c from the data signaling from the UE #3 in the data frequency allocation 305-c. As such, the network entity may isolate (e.g., relatively effectively) the PSD 330-b in the data frequency allocation 305-b for the data signaling from the UE #2 in the data frequency allocation 305-b, perform DPoD processing on the data signaling to account for the non-linearity of the signal waveform, and decode the information in the data message based at least in part on the signal waveform. That is, the network entity may use the in-band and OOB pilot signals from one or more UEs to determine the channel from multiple transmission sources (e.g., UEs) in the uplink.

In the example of FIG. 3B, the UE #2 and the UE #1 (or the UE #3) may be configured with a same frequency allocation (e.g., about 50 MHz). Additionally, or alternatively, signals transmitted by the UE #2 ad the UE #1 may experience a comparable channel response (e.g., the network entity may measure a comparable SNR of about-35 dB) and may display power amplifier characteristics that may be described by comparable models (e.g., a same known RAPP model, such as with a smoothness (p) of about 1.5 and a backoff (BO) from saturation of about 2 dB). In such an example, distortions of signals transmitted by the UE #2 may cover (e.g., occur over) frequencies allocated for UE #1 and, accordingly, distortions of signals transmitted by UE #1 may occur over frequencies allocation for UE #2. As such, a frequency allocation for the UE #2 and the UE #1 (e.g., an overall frequency allocation) may be used for pilot signals from both the UE #2 and the UE #1, such as illustrated in the example of FIG. 3A. Additionally, or alternatively, if other UEs (e.g., the UE #3) are configured with a frequency allocation that exceeds or fails to exceed the threshold (e.g., of about 50 MHz) the frequency allocation may be extended such that the frequency allocation may be use for pilot signals from the UE #1, the UE #2 and the UE #3. In some examples, by extended a frequency resources allocation over which the UEs may transmit pilot signals, the network entity may increase the reliability of communications in a multi-UE systems, among other possible benefits.

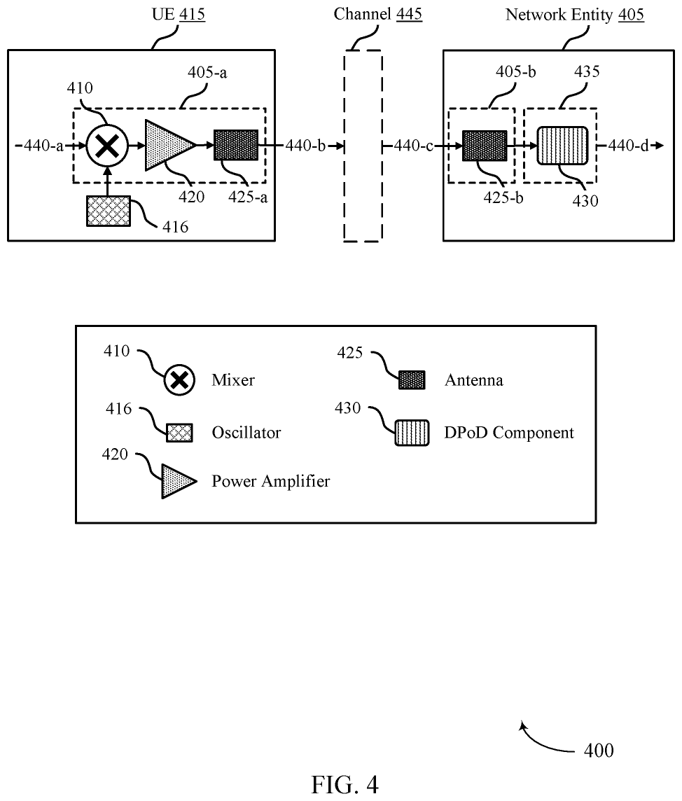

FIG. 4 illustrates an example of a DPoD processing scheme 400 that supports DPoD for uplink in accordance with one or more aspects of the present disclosure. In some examples, the DPoD processing scheme 400 may implement or be implemented by aspects of the wireless communications system 100, the wireless communications system 200, the pilot signal scheme 300, and the OOB signal interference graph 301. For example, the DPoD processing scheme 400 may include a UE 415 and a network entity 405, which may be examples of the corresponding devices as described with reference to FIGS. 1, 2, 3A, and 3B.

In some examples, the UE 415 may include a transmitter, which-in some examples—may be an aspect of a transceiver. The UE 415 may include multiple components for multiple (e.g., different) purposes. For example, the UE 415 may include an RF component 405-a. The RF component 405-a may include a mixer 410, an oscillator 416, a power amplifier 420, an antenna 425, or any combination thereof, among other components. The oscillator 416 may be an example of a local oscillator (LO). The power amplifier 420 may be an example of a high-power power amplifier and may exhibit non-linear characteristics. The network entity 405 may include a receiver with an RF component 405-b and a front-end (FE) component, such as an FE component 435. The RF component 405-b may include an antenna 425-b and the FE component 435 may include a DPoD component 430. In some examples, the FE component 435 may further include a band-pass filter, an RF amplifier, an LO, a mixer, or any combination thereof, among other components.

In some examples, the UE 415 may transmit a data message 440 to the network entity 405. To transmit the data message (e.g., a set of bits represented by a data message 440-a) may pass through the mixer 410. In some examples, the mixer 410 may work in conjunction with the oscillator 416 to change the frequency of the data message 440-a. Additionally, the data message 440-a may pass through the power amplifier 420 and an antenna 425-a (or a set of antennas) may transmit a resulting signal represented by a data message 440-b. In some examples, the power amplifier 420 may be used to increase the power of a signal (e.g., the data message 440-a), and the antenna 425-a may convert the amplified signal to radio waves. In some examples, passing the data message 440-a through the power amplifier 420 may result in another signal (e.g., the data message 440-b), that may exhibit non-linear characteristics. For example, the transmitted signal Tx(t) represented as the data message 440-b may be expressed in accordance with Equation 1:

$$Tx ( t ) = G \cdot x ( t ) + NL ( x ( t ) ) \qquad ( 1 )$$

in which G may represent a linear operator, x (t) may represent the data message 440-a (e.g., an input signal to the power amplifier), and NL may represent the effects of non-linearity (e.g., distortion) on the input signal (e.g., the data message 440-a).

In some examples, the UE 415 may transmit the signal (e.g., the signal output by the antenna 425-a, the data message 440-b) via a channel 445 (e.g., an uplink channel, a PUCCH, a PUSCH, or any other channel). In the absence of a propagation channel, a resulting signal (e.g., a received signal, a data message 440-c) may be expressed in accordance with Equation 2:

$$r ( t ) = Tx ( t ) + n ( t ) \qquad ( 2 )$$

in which n (t) may represent thermal noise and r (t) may represent the received signal (e.g., the data message 440-c). However, in the presence of a propagation channel, interference may affect the data message 440-b. For example, without DPD, one or more signals may leak into OOB resources due to non-linearity (e.g., non-linear distortions in the data message 440-b). As such, the signal received over the channel (e.g., the data message 440-c) may include in-band interference as well as OOB interference (e.g., from one or more other signals, one or more other data messages). In some examples, by normalizing the gain (G) to a value of about 1, the received signal in the frequency domain (r(f)=FT(r(t))) may be expressed in accordance with Equation 3:

$$r ( f ) = h ( f ) \cdot Tx ( f ) + n ( f ) = h ( f ) \cdot x ( f ) + n ( f ) + h ( f ) \cdot FT ( NL ( x ( t ) ) ) \qquad ( 3 )$$

in which FT represents a Fourier transform (e.g., transformation to the frequency domain), h may represent the channel 445, and f may represent the OOB frequencies and the in-band frequencies in which distortion may occur. As such, the network entity 405 may use both an estimated signal at the transmitter and a channel impulse response to compensate for the effects of the power amplifier non-linearity on the received signal. In some examples, the channel estimates may be based at least in part on pilot signals received in the same frequency band as the data message 440-c. In some examples, the pilot signals may include in-band pilot signals, OOB pilot signals, or a combination thereof.

The network entity 405 may receive the data message 440-c (e.g., the signal reprinted as the data message 440-c). For example, the data message 440-c may pass through an antenna 425-b and the network entity 405 may use a DPoD component 430 to process the data message 440-c. At the DPoD component 430, the data message 440-c may undergo DPoD processing which may include non-linear estimation in combination with channel estimation. The DPoD processing may account for distortions in the data message 440-c (e.g., due to the power amplifier 420), interference, or both. In some examples, by using the DPoD component 430, the network entity 405 may decode the data message 440-c to determine a data message 440-d (e.g., the set of bits used to generate the data message 440-a at the UE 415).

In some examples, however, the network entity 405 may communicate with multiple UEs (e.g., the UE 415 and one or more other UEs (not shown)). In such examples, data messages transmitted from the multiple UEs to the network entity 405 may leak into OOB frequencies (e.g., respective OOB frequencies for each UE) due to non-linear signal characteristics. In some examples, to mitigate the effects of channel interference due to signal leakage into OOB frequencies, the UEs may be configured to transmit pilot signals on in-band frequencies and OOB frequencies (e.g., over an extended range of frequencies, using an extended frequency DMRS coverage). For example, techniques for DPoD for uplink, as described herein, may provide for combining the estimated channel response (e.g., based at least in part on the extended frequency DMRS coverage and nonlinearity estimation for each UE both in-band and out of band) with removing (e.g., correcting for) the signal distortions for each of the multiple UEs. In some examples, such DPoD techniques may provide for removing distortion from signals transmitted by the UE 415 (e.g., self-distortion) and from the other UEs (e.g., signals occurring in adjacent frequency allocation). For example, the network entity 405 may estimate the non-linear distortion for the multiple UEs iteratively. In some examples, during an iteration, the network entity 405 may determine a correction of distortions for the multiple UEs accordance with Equation 4:

$${y}_{corrected} = y - {\hat{d}}_{x} \qquad ( 4 )$$

in which y_{corrected} may represent a corrected signal for the multiple UEs (e.g., all of the UEs), y may represent a signal received from the multiple UEs, and dx may represent an estimated non-linear distortion for the multiple UEs (e.g., a unified distortion for the multiple UEs). In some examples, the distortion (dr) may be initialized to zero (e.g., a value of dx may be set to zero for a first iteration). In some examples, based at least in part on the corrected signal (y_{corrected}), the network entity 405 may estimate the data of the received signal (y) using a slicer (or decoder). For example, the network entity 405 may estimate the data transmitted via the received signal (y) accordance with Equation 5:

$$i ∈ UE : {\hat{x}}_{i} = Slicer ( Equalizer ( {y}_{corrected}^{i} ) ) \qquad ( 5 )$$

in which \hat{x}ᵢ my represent the estimated data for the ith UE (e.g., i may correspond to a UE index).

In some examples, based at least in part on the estimated data (\hat{x}ᵢ), the network entity 405 may perform an estimation (e.g., another estimation) of the distortion (\hat{d}ₓ) in accordance with Equation 6:

$${\hat{d}}_{x} = {\sum }_{i ∈ UE} {est\_channel}_{i} ( {eff\_PA}_{i} ( {\hat{x}}_{i} ) - {\hat{x}}_{i} ) \qquad ( 6 )$$

in which est_channel; may represent the estimated channel and eff_PAᵢ may represent a model for an effective power amplifier for the ith UE (e.g., each UE). In some examples, the network entity may perform other (e.g., subsequent) iterations (e.g., perform subsequent determinations of the corrected signal (y_{corrected})) in accordance with Equation 4 (e.g., using an updated estimated distortion (dx) determined in accordance with Equation 6). In some examples, an estimation of the eff_PAᵢ for each (ith) UE may impact neighboring allocations (e.g., neighboring frequency allocations).

In some examples of DPoD for uplink, the UE 415 may enable one or more enhancements to a mapping of the nonlinearity, for example by using pilot signals (e.g., DMRSs, SRSs) with a CCDF amplitude that matches (e.g., is comparable to) a CCDF amplitude of a data signal (e.g., associated with the pilot signals). Additionally, or alternatively, in some examples of DPoD for uplink, the network entity 405 may indicate extended frequency pilots (e.g., an extended frequency range for transmitting pilot signals) to the UE 415 (e.g., and the other UEs). For example, the network entity 405 may transmit an indication of pilot signal parameters (e.g., DMRS parameters) to the UE 415. Additionally, or alternatively, the network entity 405 may transmit an indication to the UE 415 (e.g., and other UEs) a pilot signal extended frequency allocation (e.g., a DMRS extended frequency allocation, may allocation an extended range of frequency resources for transmitting pilot signals). In such an example, the UE 415 (e.g., and the other UEs) may transmit pilot signals in accordance with the indication (e.g., the indicated pilot signal parameters or the indicated pilot signal extended frequency range). In some examples, by enabling the UE 415 to transmit pilot signal over an extended frequency range, the network entity 405 may provide one or more enhancements to DPoD performed at the network entity 405, among other possible benefits.

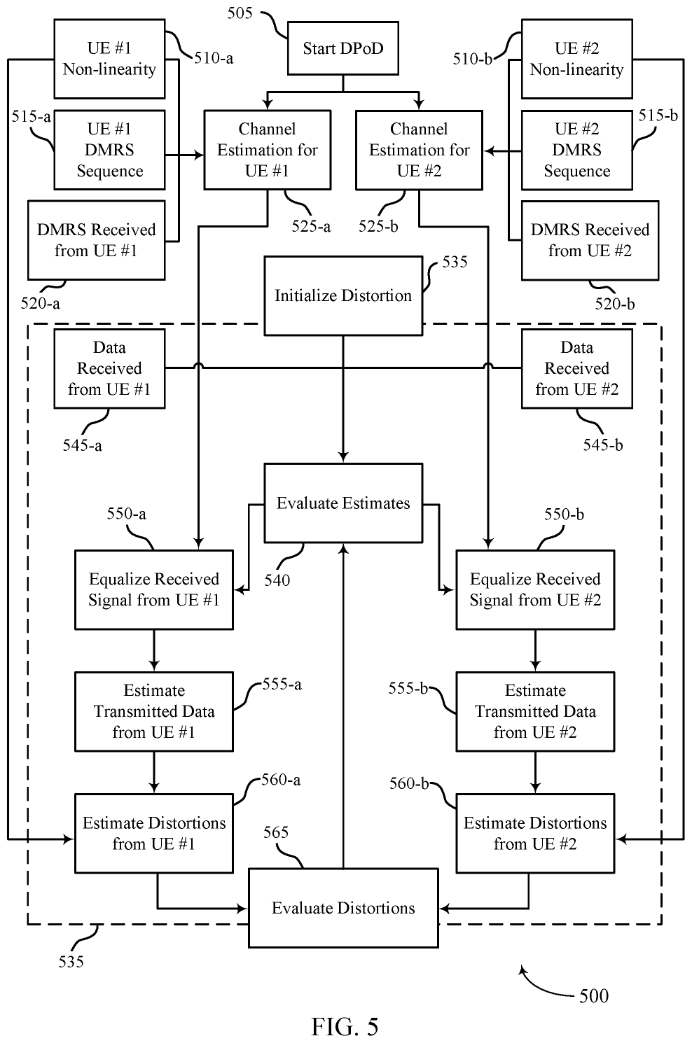

FIG. 5 illustrates an example of a block diagram 500 that supports DPoD for uplink in accordance with one or more aspects of the present disclosure. In some examples, the block diagram 500 may implement or be implemented by aspects of the wireless communications system 100, the wireless communications system 200, the pilot signal scheme 300, the OOB signal interference graph 301, and the DPoD processing scheme 400. For example, the block diagram 500 may be implemented by a UE and a network entity, which may be examples of the corresponding devices as described with reference to FIGS. 1, 2, 3A, 3B, and 4.

In some examples, the network (e.g., one or more network entities) may perform DPoD on uplink signals transmitted from multiple UEs (e.g., for multiple FDMA users). For example, the network entity may perform DPoD for multiple UEs (e.g., a first UE represented as UE #1 and a second UE represented as UE #2) that may each transmit pilot signals (e.g., DMRSs, SRSs) using FDM. The UEs may transmit the pilot signals over an extended frequency allocation (e.g., in-band frequencies and OOB frequencies). As illustrated in the example of FIG. 5, the network entity may start DPoD at 505. At 525-a and 525-b, the network entity may perform channel estimation for the first UE (e.g., UE #1) and the second UE (e.g., UE #2), respectively. The network entity may perform the channel estimation (e.g., at 525-a and 525-b) based at least in part on a non-linearity of a power amplifier at each UE used for transmitting a pilot signal (e.g., determined at 510-a and 510-b for the first UE and the second UE, respectively), a sequence of the pilot signal, such as a DMRS sequence (e.g., determined at 515-a and 515-b for the first UE and the second UE, respectively), and the received pilot signal (e.g., a DMRS received from the first UE and the second UE at 520-a and 520-b, respectively).

At 530, and based at least in part on the channel estimation for the first UE and the second UE (e.g., performed at 525-a and 525-b, respectively), the network entity may perform one or more DPoD data iterations. For example, at 535, the network entity may initialize the non-linear distortions for the first UE and the second UE (e.g., the overall non-linear distortions) in accordance with Equation 7:

$${\hat{d}}_{x} = 0. \qquad ( 7 )$$

That is, the network entity may set the non-linear distortion for the multiple UEs (e.g., a unified non-linear distortion) to zero for a first DPoD data iteration. At 540. the network ma evaluate estimates for the corrected signal (y_{corrected}) in accordance with Equation 8:

$${y}_{corrected} = y - {\hat{d}}_{x} \qquad ( 8 )$$

in which y corrected may represent a corrected signal for the multiple UEs (e.g., an estimate of the corrected signal for the overall subcarriers in the full bandwidth), y may represent a signal received from the first UE and the second UE, and dx may represent an estimated non-linear distortion for the multiple UEs (e.g., the unified distortion for the multiple UEs). The signal received from the first UE and the second UE may be a combined signal (e.g., combined in the air) including signals transmitted from the first UE and the second UE. In some examples (e.g., for a first iteration), the network entity may evaluate estimates of the corrected signal based at least in part on data received from the first UE and the second UE (e.g., at 545-a and 545-b, respective).

At 550-a and 550-b, and based at least in part on the corrected signal (e.g., determined at 540), the network entity may equalize the received signal from the first UE and the second UE, respectively. In some examples, the network entity may equalize the received signal (e.g., remove distortions from the received signal) from the first UE and the second UE (e.g., at 550-a and 550-b, respectively) in accordance with Equation 9:

$${y}_{EQ}^{i} = {Eq}_{{channel}_{i}} ( {y}_{corrected}^{i} ) \qquad ( 9 )$$

in which y_{EQ}ⁱ may represent an equalized signal for the ith UE (e.g., i may correspond to a UE index, such that i may be set to 1 for the first UE and 2 for the second UE), Eq_{channel}; may represent an equalizer (e.g., for channel equalization) of the ith UE, and y_{corrected}ⁱ may represent the corrected signal for the ith UE. In some examples, at 555-a and 555-b and based at least in part on the equalized signal y_{EQ}ⁱ, the network entity may estimate the data transmitted from each UE. For example, the network entity may estimate the data of the equalized signal (y_{EQ}ⁱ) using a slicer (or decoder). In some examples, the network entity may estimate the data transmitted via the of the equalized signal (y_{EQ}ⁱ) in accordance with Equation 10:

$${\hat{x}}_{i} = Slicer ( {y}_{EQ}^{i} ) \qquad ( 10 )$$

in which \hat{x}ᵢ may represent the estimated data for the ith UE.

At 560-a and 560-b, and based at least in part on the estimated data (\hat{x}ᵢ), the network entity may estimate the distortion (\hat{d}ₓ) for the first UE and the second UE, respectively. In some examples, the network entity may estimate the distortion for the first UE and the second UE (e.g., at 560-a and 560-b, respective) in accordance with Equation 11:

$${\hat{d}}_{x}^{i} = {est\_channel}_{i} ( {eff\_PA}_{i} ( {\hat{x}}_{i} ) - {\hat{x}}_{i} ) \qquad ( 11 )$$

in which est_channel; may represent the estimated channel and eff_PAᵢ may represent a model for an effective power amplifier for the ith UE.

At 565, the network entity may evaluate the distortion for the multiple UEs (e.g., the overall distortion, the unified distortion). In some example, the network entity may evaluate the distortion in accordance with equation 12:

$${\hat{d}}_{x} = {\hat{d}}_{x}^{1} + {\hat{d}}_{x}^{2} \qquad ( 12 )$$

in which \hat{d}ₓ¹ may represent the distortion for the first UE and \hat{d}ₓ² may represent the distortion for the second UE. In some examples, and based at least in part on the evaluated distortions (e.g., at 565) the network entity may perform one (or more) subsequent iterations. For example, at 540, the network entity may evaluate estimates (e.g., updated estimates) based at least in part on the distortions evaluated at 565. In some examples, by performing one or more DPoD data iterations, the network entity may provide one or more enhancements to signal processing at the network entity, thereby improving the reliability of communications between the network entity and the UEs, among other possible benefits.

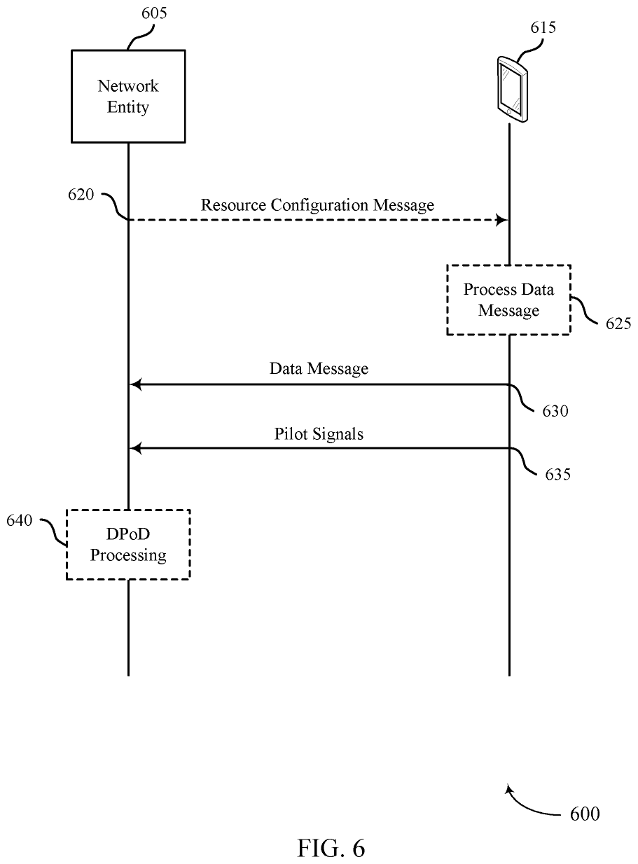

FIG. 6 illustrates an example of a process flow 600 that supports DPoD for uplink in accordance with one or more aspects of the present disclosure. In some examples, the process flow 600 may implement aspects of the wireless communications system 100, the wireless communications system 200, the pilot signal scheme 300, the OOB signal interference graph 301, the DPoD processing scheme 400, and the block diagram 500. For example, the process flow 600 may include a UE 615 and a network entity 605, which may be examples of the corresponding devices as described with reference to FIGS. 1, 2, 3A, 3B, 4, and 5. For uplink communications, the UE 615 may be an example of a transmitting device (e.g., a transmitter) and the network entity 605 may be an example of a receiving device (e.g., a receiver). In some examples, the UE 615 may utilize non-linear components such as a power amplifier to transmit a data message to the network entity 605. Non-linearity may cause the transmitted signal to leak into OOB frequencies (e.g., frequency resources outside of the frequency resources allocated for the data transmission by the UE 615). In some examples, the UE 615 may transmit pilot signals in the OOB frequency resources to support OOB channel estimation by the network entity 605, thereby mitigating the effects of the non-linearity of the data message. The network entity 605 and the UE 615 may implement one or more techniques described herein to mitigate OOB interference during DPoD operations. In the following description of the process flow 600, operations between the network entity 605 and the UE 615 may occur in a different order or at different times than as shown. Some operations may also be omitted from the process flow 600, and other operations may be added to the process flow 600. The process flow 600 may include features for improved communications between the UE and the network, among other benefits.

At 620, the UE 615 may receive a resource configuration message to the UE 615. The resource configuration message may indicate to the UE 615 a set of OOB resources for transmitting OOB pilot signals. For example, the resource configuration message may instruct the UE 615 to expand the resources for transmitting pilot signaling from the resources for transmitting uplink messages to include additional regions where non-linearity may be expected (e.g., where the non-linear effects may cause non-negligible interference). Additionally, or alternatively, the resource configuration message may indicate (e.g., define) a saturation level of a power amplifier at the UE 615. In some examples, the indicated saturation level may identify (e.g., based on a table or model) a span of OOB frequencies (e.g., the set of OOB resources for transmitting OOB pilot signals).

In some examples, the resource configuration message may be an RRC configuration message, DCI message, or any other downlink message. In some examples, the resource configuration message may be based at least in part on the UE capability message received at 620. Additionally, or alternatively, the network entity 605 may configure the UE 615 with resources for transmitting OOB pilot signals via a pilot signal (e.g., DMRS) extended frequency allocation. For example, the network entity 605 may indicate to each UE (e.g., to the UE 615 and one or more other UEs) a respective extended DMRS coverage (e.g., an extended pilot signal frequency allocation). In some examples, a separation (e.g., frequency resource separation) may be used between UEs that may transmit pilot signals in overlapping frequency bands (e.g., DMRS frequency coverage bands). For example, the network may configure a UE (e.g., of the UEs transmitting pilot signals in overlapping frequency bands) to transmit pilot signals over odd subcarriers and another UE (e.g., of the UEs transmitting pilot signals in overlapping frequency bands) to transmit pilot signals over even subcarriers. In some examples, such a separation may enable orthogonality to be maintained (e.g., in the presence of the non-linearity). In some examples, the pilot signal frequency resource allocation (e.g., the DMRS coverage) may include coverage of the distortion (e.g., the overall distortion) that may result from the UE 615 and adjacent UEs (e.g., may consider a non-linearity configuration that may be requested by the UE 615).

In some other examples, the network entity 605 may indicate pilot signal parameters (e.g., DMRS parameters) to the UE 615 that the UE 615 may use to determine resources for transmitting OOB pilot signals. For example, the network may indicate parameters for DMRS generation (e.g., to enable the UE 615 to generate a desired CCDF). For example, for estimation of a non-linear function (e.g., due to power amplifier compression at the UE 615) that operated on data of a received signal, the received signal (e.g., a DMRS signal) may have an amplitude CCDF that matches the data amplitude CCDF. In some examples, a process for generating the DMRS sequences may be performed by the UE 615 and selected (e.g., and tabulated), such that the amplitude of the CCDF associated with the DMRS signal (e.g., the pilot signal) may be comparable to the amplitude of the CCDF associated with the data signal (e.g., based at least in part on desired CCDF properties). For example, the network entity 605 may indicate, to the UE 615, a level of non-linearity (or a non-linearity type) to be used at the UE 615 (e.g., for transmitting signals). In some examples, the network entity 605 may indicate the level of non-linearity using non-linear characteristics, or an OOB frequency span (e.g., a maximal OOB frequency span of multiple OOB frequency spans supported at the UE 615 or an otherwise suitable OOB frequency span), or both. In response, the UE 615 may transmit data signals with a matching non-linearity using in-band frequencies and pilot signals with a matching non-linearity using the OOB frequency span. In some examples (e.g., absent an indication of a non-linearity level), the UE 615 may apply a default non-linearity level that may not rely on non-linearity compensation (e.g., at the network entity 605 using DPoD).

In some examples, generation of the DMRS signals (e.g., DMRS signals with CCDF amplitudes that match a CCDF amplitude of the corresponding data signals) may include selecting a first set of resource elements (e.g., about 50% of a quantity of resource elements to be used for transmitting the DMRS signals), such as based at least in part on some polynomial generation. In such examples, remaining resource elements may be added sequentially (e.g., QPSK samples may be added sequentially, resource element by resource element). For example, each value of the QPSK may be selected (e.g., sequentially), such that the amplitude of the CCDF associated with the DMRS signal may approach the amplitude of the CCDF associated with the data signal (e.g., may approach the desired CCDF). In some examples, a number (e.g., about 4) CCDF hypotheses may be calculated per QPSK symbol and a QPSK symbol that reduces (e.g., minimizes) a difference (e.g., a gap) between the amplitude of the CCDF associated with the DMRS signal and the amplitude of the CCDF associated with the data signal (e.g., the desired CCDF may be selected). In such examples, once the QPSK symbol is selected, the selected symbol may be stored (e.g., fixed) and the UE may proceed to select another (e.g., a next resource element value, a subsequent resource element value). In some examples, once a pilot signal is selected (e.g., once a DMRS signal is selected), the selected signal may be tabulated and parameters of the signal may be communicated between the UE 615 and the network entity 605.

At 625, the UE 615 may process a data message for transmission, where the processing may result in a non-linear signal for the data message (e.g., an over-the-air signal including one or more non-linear characteristics). For example, the data message may pass through a high-power power amplifier resulting in power gain and causing a non-linear increase in output power. That is, the data message may exhibit non-linear characteristics based at least in part on the processing (e.g., power amplification) of the message. However, the processing may not include a DPD process, and thus may not mitigate non-linear characteristics at the transmitter-side.

At 630, the UE 615 may transmit the data message to the network entity 605. In some examples, the UE 615 may transmit the data message on a first set of frequency resources. For example, the UE 615 may transmit the data message over a set of frequencies allocated to the UE 615 for transmitting data message. In some examples, such frequencies may be an example of a data frequency resource allocation as described with reference to FIGS. 3A and 3B. In some examples, the data message may exhibit non-linear characteristics. The non-linear characteristics of the data message may cause distortion to leak into OOB frequencies (e.g., frequencies resources located outside the resources allocated for data communications).

At 635, the UE 615 may transmit one or more pilot signals to the network entity 605. For example, the UE 615 may transmit a pilot signal associated with the data message (e.g., transmitted at 635) on a set of subcarriers within a second set of frequency resources. The first set of frequency resources (e.g., used to transmit the data signal at 635) may be a subset of the second set of frequency resources. In some examples, the set of subcarriers may include odd or even indexed subcarriers within the second set of frequency resources. For example, a first portion of the set of subcarriers may occur within the first set of frequency resources and a second portion of the set of subcarriers may occur within the second set of frequency resources (e.g., and outside the first set of frequency resources). That is, the first set of frequency resources may correspond to in-band frequency resources allocated to the UE 615 for transmitting data signals and the second set of frequency resources may correspond to an extended pilot signal frequency resource allocation for the UE 615 to transmit pilot signals. In some examples, the UE 615 may transmit the one or more pilot signals in accordance with a DMRS structure (e.g., based at least in part on the DMRS parameters indicated to the UE 615 from the network entity 605). In some examples, the DMRS structure may be an example of a DMRS pilot signal scheme as described with reference to FIG. 3A.

At 640, the network entity 605 may perform DPoD operations, for example to mitigate the effects of non-linearity on the message received from the UE 615 at 620. For example, the network entity 605 may perform a DPoD technique on multiple data messages from multiple UEs (e.g., the data message and one or more other data messages of a second UE). In some examples, the network entity 605 may decode the data message (e.g., and one or more other data messages from the second UE) based at least in part on performing the DPoD technique. In some examples, by transmitting pilot signals on the set of subcarriers within the second set of frequency resources, the UE 615 may provide one or more enhancements to the DPoD techniques performed at the network entity 605, among other possible benefits. For example, the transmission of pilot signals on the set of subcarriers within the second set of frequency resources may enable the network entity 605 to mitigate interference for OOB signals that the network entity 605 may have otherwise been incapable of mitigating.

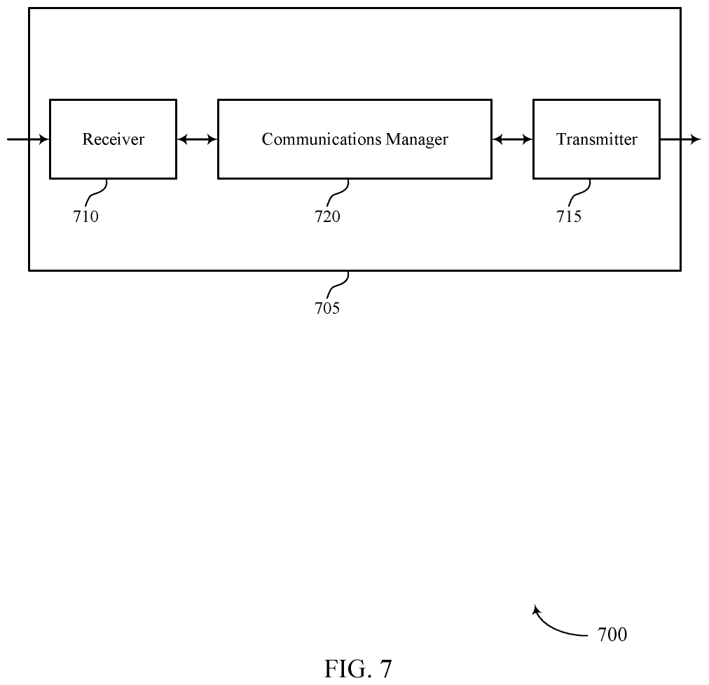

FIG. 7 shows a block diagram 700 of a device 705 that supports DPoD for uplink in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to DPoD for uplink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to DPoD for uplink). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of DPoD for uplink as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. For example, the communications manager 720 may be configured as or otherwise support a means for transmitting a data message on a first set of frequency resources. The communications manager 720 may be configured as or otherwise support a means for transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption and more efficient utilization of communication resources.

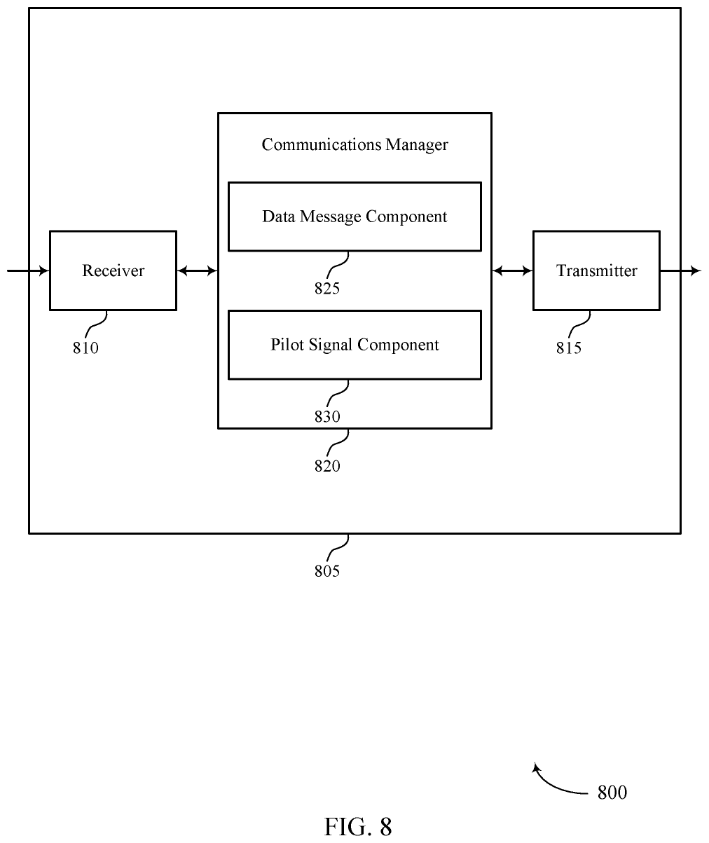

FIG. 8 shows a block diagram 800 of a device 805 that supports DPoD for uplink in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to DPoD for uplink). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to DPoD for uplink). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of DPoD for uplink as described herein. For example, the communications manager 820 may include a data message component 825 a pilot signal component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE (e.g., the device 805) in accordance with examples as disclosed herein. The data message component 825 may be configured as or otherwise support a means for transmitting a data message on a first set of frequency resources. The pilot signal component 830 may be configured as or otherwise support a means for transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

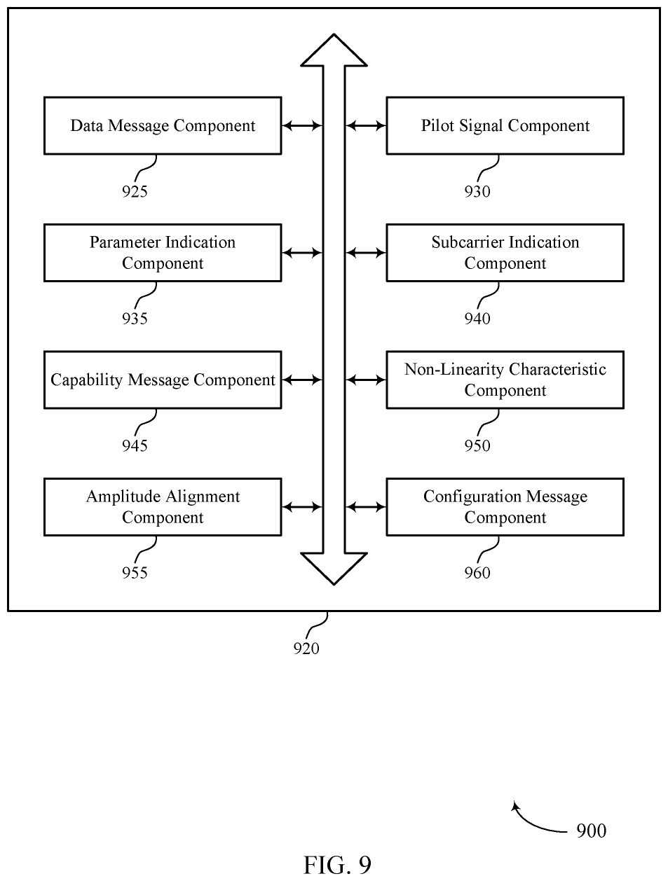

FIG. 9 shows a block diagram 900 of a communications manager 920 that supports DPoD for uplink in accordance with one or more aspects of the present disclosure. The communications manager 920 may be an example of aspects of a communications manager 720, a communications manager 820, or both, as described herein. The communications manager 920, or various components thereof, may be an example of means for performing various aspects of DPoD for uplink as described herein. For example, the communications manager 920 may include a data message component 925, a pilot signal component 930, a parameter indication component 935, a subcarrier indication component 940, a capability message component 945, a non-linearity characteristic component 950, an amplitude alignment component 955, a configuration message component 960, or any combination thereof. Each of these components may communicate, directly or indirectly, with one another (e.g., via one or more buses).

The communications manager 920 may support wireless communication at a UE in accordance with examples as disclosed herein. The data message component 925 may be configured as or otherwise support a means for transmitting a data message on a first set of frequency resources. The pilot signal component 930 may be configured as or otherwise support a means for transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

In some examples, the parameter indication component 935 may be configured as or otherwise support a means for receiving, from a network entity, an indication of a set of one or more parameters for the UE to use to determine the pilot signal for the set of subcarriers based at least in part on the data message, where transmitting the pilot signal is based at least in part on the set of one or more parameters. In some examples, the subcarrier indication component 940 may be configured as or otherwise support a means for receiving, from a network entity, an indication identifying the set of subcarriers for the UE to use to transmit the pilot signal, where transmitting the pilot signal is based at least in part on the indication identifying the set of subcarriers.

In some examples, the capability message component 945 may be configured as or otherwise support a means for transmitting, to a network entity, a UE capability message indicating a first capability of the UE to transmit the data message for DPoD processing at the network entity, a second capability of the UE to transmit a plurality of pilot signals distributed across the second set of frequency resources, or a combination thereof, where transmitting the pilot signal outside the first set of frequency resources is based at least in part on the UE capability message.

In some examples, the configuration message component 960 may be configured as or otherwise support a means for receiving, from the network entity and in response to the UE capability message, a configuration message configuring the UE to implement the first capability, the second capability, or a combination thereof, where transmitting the pilot signal is further based at least in part on the configuration message. In some examples, the set of subcarriers includes all of the one of odd or even indexed subcarriers of the second set of frequency resources. In some examples, the set of subcarriers includes every fourth subcarrier within the second set of frequency resources.

In some examples, the first set of frequency resources further includes a second set of subcarriers for a second pilot signal of a second UE that is associated with a data message of the second UE transmitted on frequency resources outside the first set of frequency resources, and the second set of subcarriers includes a different one of the odd or even indexed subcarriers within a first portion of the first set of frequency resources.

In some examples, the first set of frequency resources further includes a third set of subcarriers for a third pilot signal of a third UE that is associated with a data message of the third UE transmitted on frequency resources outside the first set of frequency resources, and the third set of subcarriers includes the different one of the odd or even indexed subcarriers within a second portion of the first set of frequency resources different than the first portion.

In some examples, the first set of frequency resources includes first frequency resources allocated for data communications of the first UE, and the non-linearity characteristic component 950 may be configured as or otherwise support a means for determining the second frequency resources based at least in part on an estimated non-linearity characteristic of the data message.

In some examples, to support determining the second frequency resources, the non-linearity characteristic component 950 may be configured as or otherwise support a means for selecting the second frequency resources based at least in part on the estimated non-linearity characteristic of the data message satisfying an interference threshold for the second frequency resources. In some examples, the pilot signal includes a DMRS.

In some examples, the amplitude alignment component 955 may be configured as or otherwise support a means for aligning a first amplitude associated with a CCDF of the pilot signal with a second amplitude associated with the CCDF of the data message. In some examples, the pilot signal component 930 may be configured as or otherwise support a means for transmitting the pilot signal based at least in part on the alignment.

In some examples, to support aligning the first amplitude with the second amplitude, the pilot signal component 930 may be configured as or otherwise support a means for selecting a first portion of resources of a set of resources for transmitting the pilot signal according to a polynomial generation technique. In some examples, to support aligning the first amplitude with the second amplitude, the pilot signal component 930 may be configured as or otherwise support a means for selecting a second portion of resources of the set of resources for transmitting the pilot signal sequentially based at least in part on a difference between the first amplitude associated with the CCDF of the pilot signal and the second amplitude associated with the CCDF of the data message, where the pilot signal is transmitted using the set of resources.

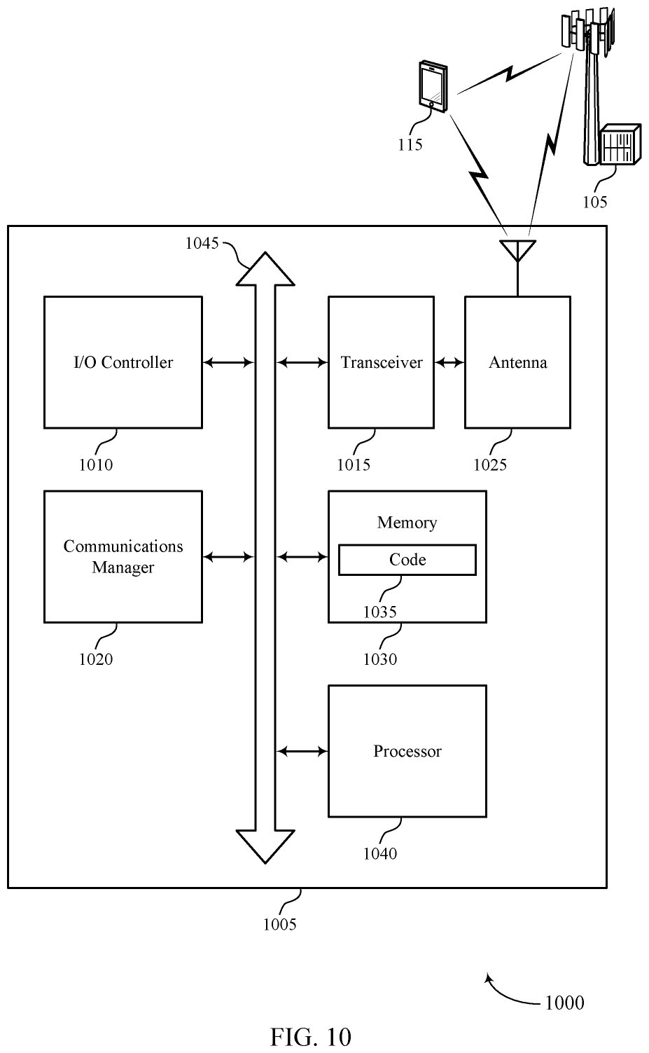

FIG. 10 shows a diagram of a system 1000 including a device 1005 that supports DPoD for uplink in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOSR, ANDROIDR, MS-DOSR, MS-WINDOWS®, OS/2R, UNIXR, LINUXR, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting DPoD for uplink). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE (e.g., the device 1005) in accordance with examples as disclosed herein. For example, the communications manager 1020 may be configured as or otherwise support a means for transmitting a data message on a first set of frequency resources. The communications manager 1020 may be configured as or otherwise support a means for transmitting a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

By including or configuring the communications manager 1020 in accordance with examples as described herein, the device 1005 may support techniques for improved communication reliability, reduced latency, reduced power consumption, more efficient utilization of communication resources, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of DPoD for uplink as described herein, or the processor 1040 and the memory 1030 may be otherwise configured to perform or support such operations.

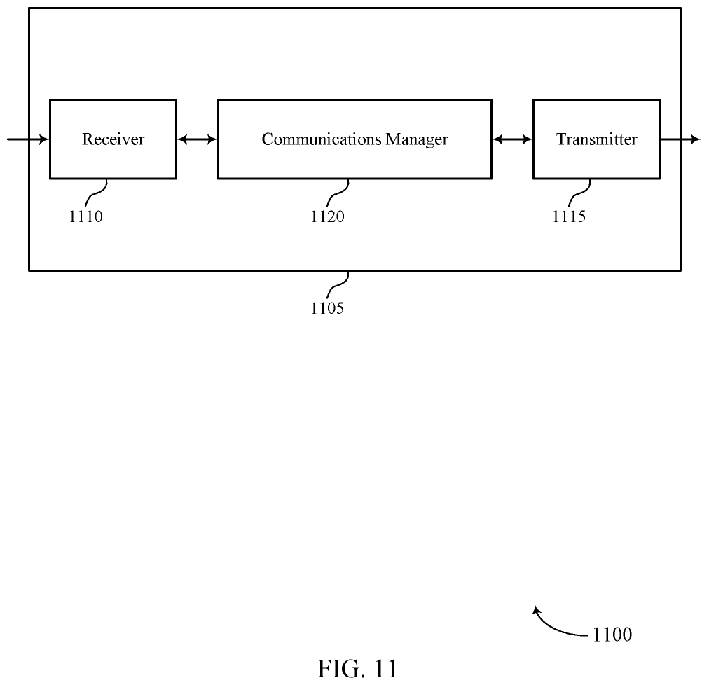

FIG. 11 shows a block diagram 1100 of a device 1105 that supports DPoD for uplink in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of DPoD for uplink as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for receiving, from a UE, a data message on a first set of frequency resources. The communications manager 1120 may be configured as or otherwise support a means for receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced power consumption and more efficient utilization of communication resources.

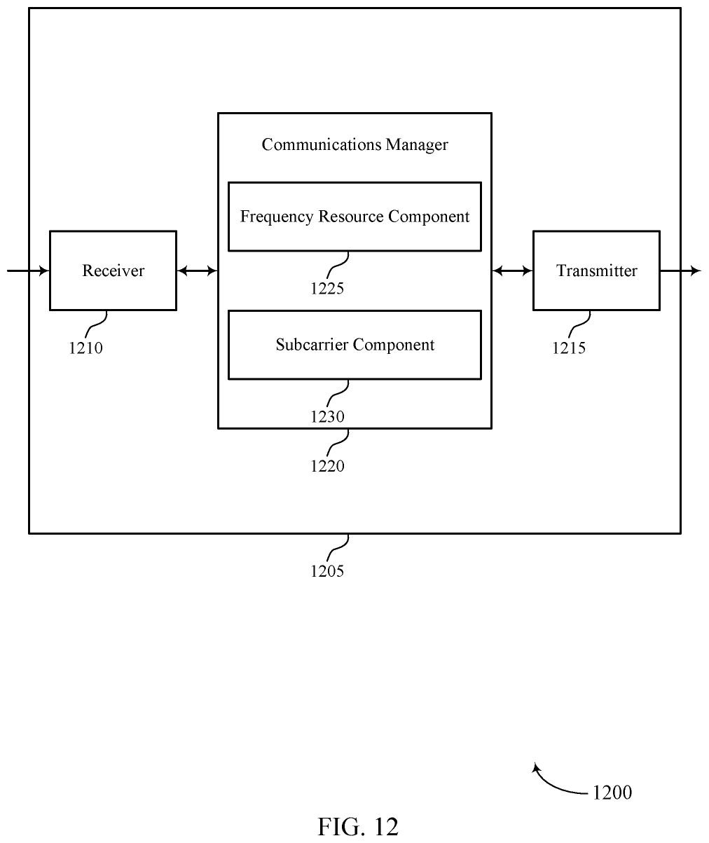

FIG. 12 shows a block diagram 1200 of a device 1205 that supports DPoD for uplink in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of DPD for uplink as described herein. For example, the communications manager 1220 may include a frequency resource component 1225 a subcarrier component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The frequency resource component 1225 may be configured as or otherwise support a means for receiving, from a UE, a data message on a first set of frequency resources. The subcarrier component 1230 may be configured as or otherwise support a means for receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

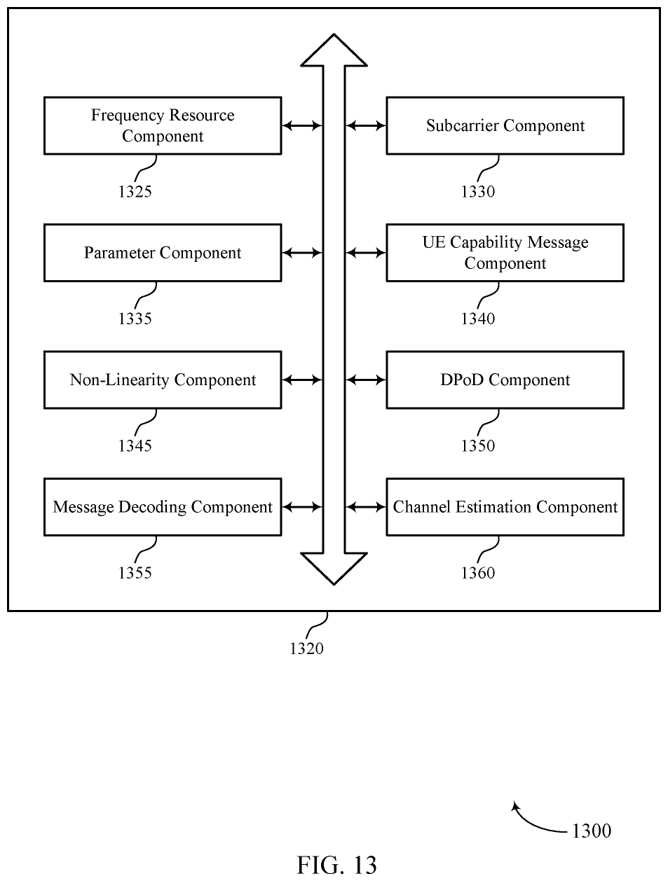

FIG. 13 shows a block diagram 1300 of a communications manager 1320 that supports DPoD for uplink in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of DPoD for uplink as described herein. For example, the communications manager 1320 may include a frequency resource component 1325, a subcarrier component 1330, a parameter component 1335, a UE capability message component 1340, a non-linearity component 1345, a DPoD component 1350, a message decoding component 1355, a channel estimation component 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The frequency resource component 1325 may be configured as or otherwise support a means for receiving, from a UE, a data message on a first set of frequency resources. The subcarrier component 1330 may be configured as or otherwise support a means for receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

In some examples, the parameter component 1335 may be configured as or otherwise support a means for transmitting, to the UE, an indication of a set of one or more parameters for the UE to use to determine the pilot signal for the set of subcarriers based at least in part on the data message, where receiving the pilot signal is based at least in part on the set of one or more parameters. In some examples, the subcarrier component 1330 may be configured as or otherwise support a means for transmitting, to the UE, an indication identifying the set of subcarriers for the UE to use to transmit the pilot signal, where receiving the pilot signal is based at least in part on the indication identifying the set of subcarriers.

In some examples, the UE capability message component 1340 may be configured as or otherwise support a means for receiving, from the UE, a UE capability message indicating a first capability of the UE to transmit the data message for DPoD processing at the network entity, a second capability of the UE to transmit a plurality of pilot signals distributed across the second set of frequency resources, or a combination thereof, where receiving the pilot signal is based at least in part on the UE capability message.

In some examples, the UE capability message component 1340 may be configured as or otherwise support a means for transmitting, to the UE in response to the UE capability message, a configuration message configuring the UE to implement the first capability, the second capability, or a combination thereof, where receiving the pilot signal is further based at least in part on the configuration message. In some examples, the set of subcarriers includes all of the one of odd or even indexed subcarriers of the second set of frequency resources. In some examples, the set of subcarriers includes every fourth subcarrier within the second set of frequency resources.

In some examples, the frequency resource component 1325 may be configured as or otherwise support a means for receiving, from a second UE, a second data message on a third set of frequency resources, where the third set of frequency resources overlaps at least a portion of the second set of frequency resources. In some examples, the subcarrier component 1330 may be configured as or otherwise support a means for receiving, from the second UE, a second pilot signal associated with the second data message on a second set of subcarriers, where the second set of subcarriers includes a different one of the odd or even indexed subcarriers within the third set of frequency resources, a first portion of the second set of subcarriers are within the first set of frequency resources, and a second portion of the second set of subcarriers are within the second set of frequency resources.

In some examples, the frequency resource component 1325 may be configured as or otherwise support a means for receiving, from a third UE, a third data message on a fourth set of frequency resources, where the fourth set of frequency resources overlaps at least a portion of the second set of frequency resources, and is outside the third set of frequency resources. In some examples, the subcarrier component 1330 may be configured as or otherwise support a means for receiving, from the third UE, a third pilot signal associated with the third data message on a third set of subcarriers, where the third set of subcarriers includes the different one of the odd or even indexed subcarriers within the fourth set of frequency resources, a first portion of the third set of subcarriers are within the first set of frequency resources, and a second portion of the third set of subcarriers are within the second set of frequency resources.

In some examples, the first set of frequency resources includes first frequency resources allocated for data communications of the first UE, and the non-linearity component 1345 may be configured as or otherwise support a means for determining the second frequency resources for the UE based at least in part on an estimated non-linearity characteristic of the data message.

In some examples, to support determining the second frequency resources, the non-linearity component 1345 may be configured as or otherwise support a means for selecting the second frequency resources for the UE based at least in part on the estimated non-linearity characteristic satisfying an interference threshold for the second frequency resources for the UE.

In some examples, signaling associated with the data message may include a non-linearity characteristic and the DPoD component 1350 may be configured as or otherwise support a means for performing a DPoD technique on the data message and at least one other data message of a second UE. In some examples, the message decoding component 1355 may be configured as or otherwise support a means for decoding the data message and the at least one other data message based at least in part on performing the DPoD technique.

In some examples, the channel estimation component 1360 may be configured as or otherwise support a means for performing channel estimation based at least in part on the pilot signal associated with the data message. In some examples, the message decoding component 1355 may be configured as or otherwise support a means for decoding the data message based at least in part on the channel estimation. In some examples, the pilot signal includes a DMRS.

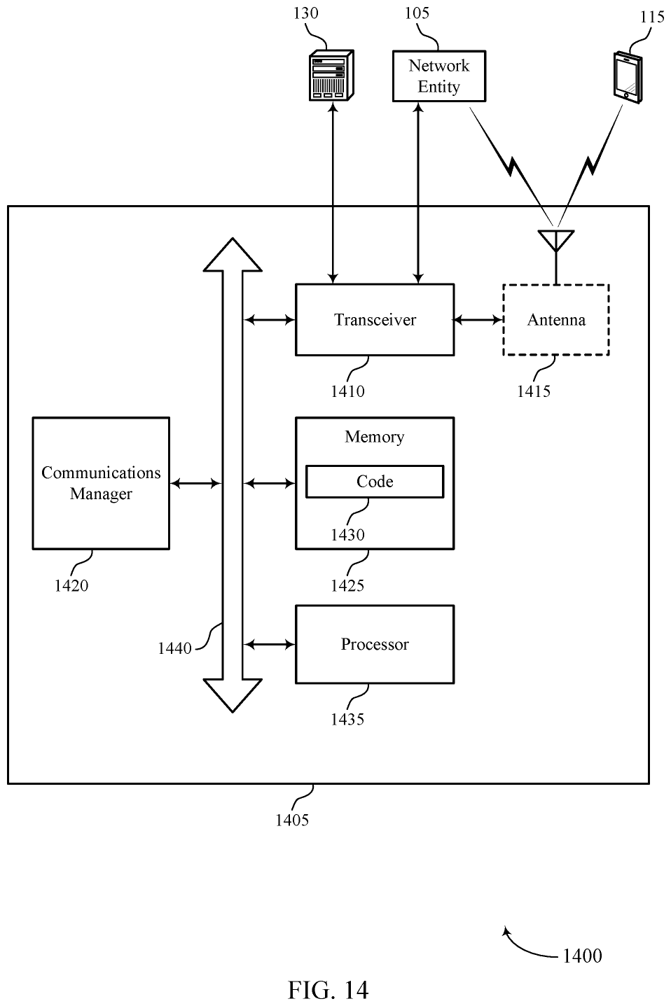

FIG. 14 shows a diagram of a system 1400 including a device 1405 that supports DPoD for uplink in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting DPoD for uplink). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an interface within an wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for receiving, from a UE, a data message on a first set of frequency resources. The communications manager 1420 may be configured as or otherwise support a means for receiving, from the UE, a pilot signal associated with the data message on a set of subcarriers within a second set of frequency resources, where the first set of frequency resources is a subset of the second set of frequency resources, the set of subcarriers includes one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

By including or configuring the communications manager 1420 in accordance with examples as described herein, the device 1405 may support techniques for improved communication reliability, reduced latency, reduced power consumption, more efficient utilization of communication resources, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of DPoD for uplink as described herein, or the processor 1435 and the memory 1425 may be otherwise configured to perform or support such operations.

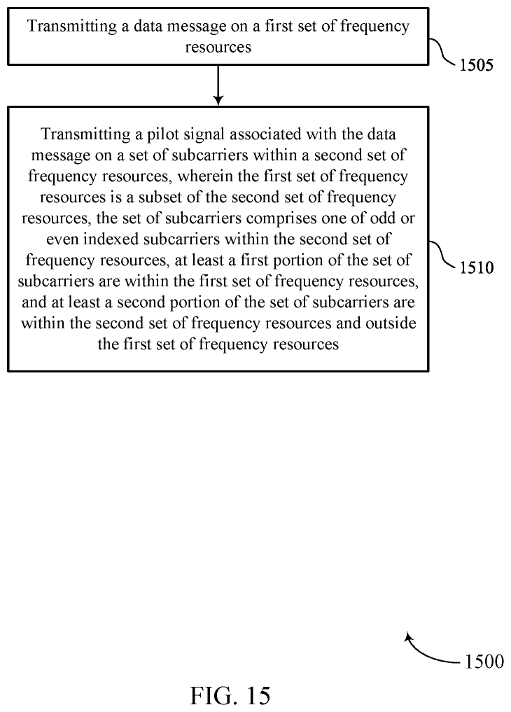

FIG. 15 shows a flowchart illustrating a method 1500 that supports DPoD for uplink in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a data message on a first set of frequency resources. The operations of 1505 may be performed in accordance with examples as disclosed herein. In some examples, aspects of the operations of 1505 may be performed by a data message component 925 as described with reference to FIG. 9.

At 1510, the method may include transmitting a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources. The operations of 1510 may be performed in accordance with examples as disclosed herein. In some examples, aspects of the operations of 1510 may be performed by a pilot signal component 930 as described with reference to FIG. 9.

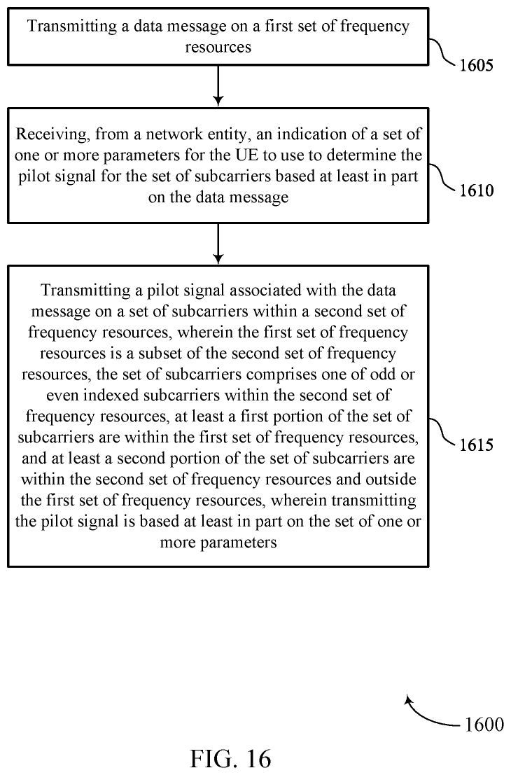

FIG. 16 shows a flowchart illustrating a method 1600 that supports DPoD for uplink in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a data message on a first set of frequency resources. The operations of 1605 may be performed in accordance with examples as disclosed herein. In some examples, aspects of the operations of 1605 may be performed by a data message component 925 as described with reference to FIG. 9.

At 1610, the method may include receiving, from a network entity, an indication of a set of one or more parameters for the UE to use to determine the pilot signal for the set of subcarriers based at least in part on the data message. The operations of 1610 may be performed in accordance with examples as disclosed herein. In some examples, aspects of the operations of 1610 may be performed by a parameter indication component 935 as described with reference to FIG. 9.

At 1615, the method may include transmitting a pilot signal associated with the data message on a set of subcarriers within a second set of frequency resources, where the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources, wherein transmitting the pilot signal is based at least in part on the set of one or more parameters. The operations of 1615 may be performed in accordance with examples as disclosed herein. In some examples, aspects of the operations of 1615 may be performed by a pilot signal component 930 as described with reference to FIG. 9.

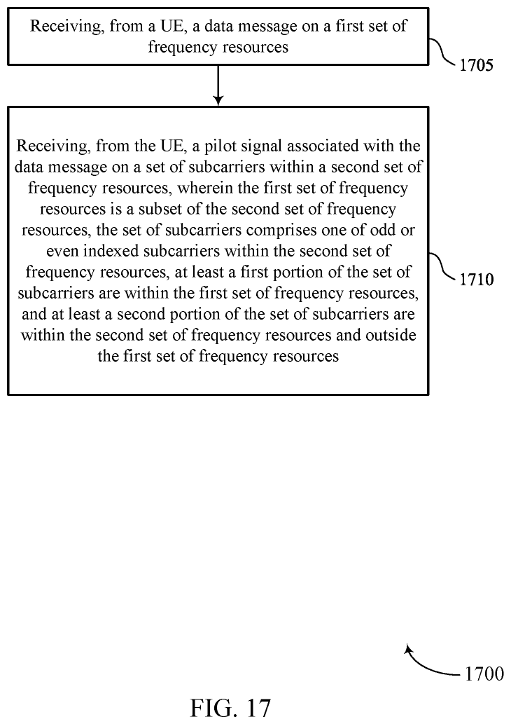

FIG. 17 shows a flowchart illustrating a method 1700 that supports DPoD for uplink in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from a UE, a data message on a first set of frequency resources. The operations of 1705 may be performed in accordance with examples as disclosed herein. In some examples, aspects of the operations of 1705 may be performed by a frequency resource component 1325 as described with reference to FIG. 13.

At 1710, the method may include receiving, from the UE, a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources. The operations of 1710 may be performed in accordance with examples as disclosed herein. In some examples, aspects of the operations of 1710 may be performed by a subcarrier component 1330 as described with reference to FIG. 13.

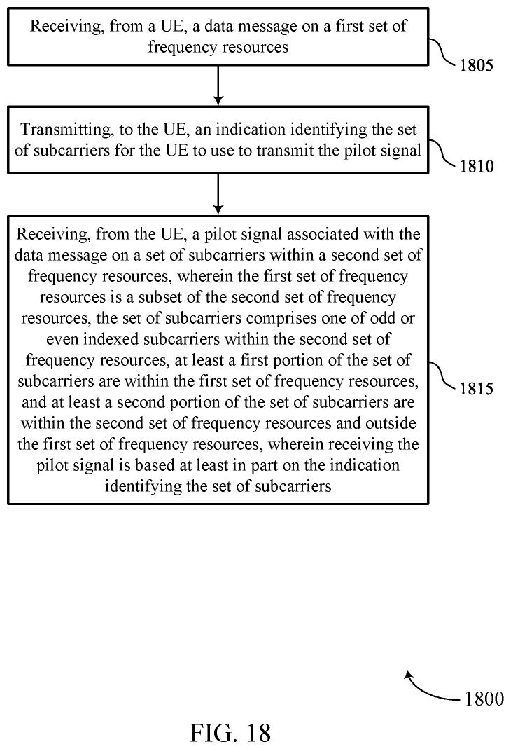

FIG. 18 shows a flowchart illustrating a method 1800 that supports DPoD for uplink in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a UE, a data message on a first set of frequency resources. The operations of 1805 may be performed in accordance with examples as disclosed herein. In some examples, aspects of the operations of 1805 may be performed by a frequency resource component 1325 as described with reference to FIG. 13.

At 1810, the method may include transmitting, to the UE, an indication identifying the set of subcarriers for the UE to use to transmit the pilot signal. The operations of 1810 may be performed in accordance with examples as disclosed herein. In some examples, aspects of the operations of 1810 may be performed by a subcarrier component 1330 as described with reference to FIG. 13.

At 1815, the method may include receiving, from the UE, a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources, wherein receiving the pilot signal is based at least in part on the indication identifying the set of subcarriers. The operations of 1815 may be performed in accordance with examples as disclosed herein. In some examples, aspects of the operations of 1815 may be performed by a subcarrier component 1330 as described with reference to FIG. 13.

The following provides an overview of aspects of the present disclosure:

Aspect 1: A method for wireless communication at a UE, comprising: transmitting a data message on a first set of frequency resources; and transmitting a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Aspect 2: The method of aspect 1, further comprising: receiving, from a network entity, an indication of a set of one or more parameters for the UE to use to determine the pilot signal for the set of subcarriers based at least in part on the data message, wherein transmitting the pilot signal is based at least in part on the set of one or more parameters.

Aspect 3: The method of any of aspects 1 through 2, further comprising: receiving, from a network entity, an indication identifying the set of subcarriers for the UE to use to transmit the pilot signal, wherein transmitting the pilot signal is based at least in part on the indication identifying the set of subcarriers.

Aspect 4: The method of any of aspects 1 through 3, further comprising: transmitting, to a network entity, a UE capability message indicating a first capability of the UE to transmit the data message for DPoD processing at the network entity, a second capability of the UE to transmit a plurality of pilot signals distributed across the second set of frequency resources, or a combination thereof, wherein transmitting the pilot signal outside the first set of frequency resources is based at least in part on the UE capability message.

Aspect 5: The method of aspect 4, further comprising: receiving, from the network entity and in response to the UE capability message, a configuration message configuring the UE to implement the first capability, the second capability, or a combination thereof, wherein transmitting the pilot signal is further based at least in part on the configuration message.

Aspect 6: The method of any of aspects 1 through 5, wherein the set of subcarriers comprises all of the one of odd or even indexed subcarriers of the second set of frequency resources.

Aspect 7: The method of any of aspects 1 through 5, wherein the set of subcarriers comprises every fourth subcarrier within the second set of frequency resources.

Aspect 8: The method of any of aspects 1 through 5, wherein the first set of frequency resources further comprises a second set of subcarriers for a second pilot signal of a second UE that is associated with a data message of the second UE transmitted on frequency resources outside the first set of frequency resources, and the second set of subcarriers comprises a different one of the odd or even indexed subcarriers within a first portion of the first set of frequency resources.

Aspect 9: The method of aspect 8, wherein the first set of frequency resources further comprises a third set of subcarriers for a third pilot signal of a third UE that is associated with a data message of the third UE transmitted on frequency resources outside the first set of frequency resources, and the third set of subcarriers comprises the different one of the odd or even indexed subcarriers within a second portion of the first set of frequency resources different than the first portion.

Aspect 10: The method of any of aspects 1 through 9, wherein the first set of frequency resources comprises first frequency resources allocated for data communications of the first UE, and wherein the second set of frequency resources comprises the first frequency resources allocated for data communications of the first UE and second frequency resources unallocated for the data communications of the first UE, the method further comprising: determining the second frequency resources based at least in part on an estimated non-linearity characteristic of the data message.

Aspect 11: The method of aspect 10, wherein determining the second frequency resources comprises: selecting the second frequency resources based at least in part on the estimated non-linearity characteristic of the data message satisfying an interference threshold for the second frequency resources.

Aspect 12: The method of any of aspects 1 through 11, wherein the pilot signal comprises a DMRS.

Aspect 13: The method of any of aspects 1 through 12, further comprising: aligning a first amplitude associated with a complementary cumulative distribution function of the pilot signal with a second amplitude associated with the complementary cumulative distribution function of the data message; and transmitting the pilot signal based at least in part on the alignment.

Aspect 14: The method of aspect 13, wherein aligning the first amplitude with the second amplitude comprises: selecting a first portion of resources of a set of resources for transmitting the pilot signal according to a polynomial generation technique; and selecting a second portion of resources of the set of resources for transmitting the pilot signal sequentially based at least in part on a difference between the first amplitude associated with the complementary cumulative distribution function of the pilot signal and the second amplitude associated with the complementary cumulative distribution function of the data message, wherein the pilot signal is transmitted using the set of resources.

Aspect 15: A method for wireless communication at a network entity, comprising: receiving, from a UE, a data message on a first set of frequency resources; and receiving, from the UE, a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

Aspect 16: The method of aspect 15, further comprising: transmitting, to the UE, an indication of a set of one or more parameters for the UE to use to determine the pilot signal for the set of subcarriers based at least in part on the data message, wherein receiving the pilot signal is based at least in part on the set of one or more parameters.

Aspect 17: The method of any of aspects 15 through 16, further comprising: transmitting, to the UE, an indication identifying the set of subcarriers for the UE to use to transmit the pilot signal, wherein receiving the pilot signal is based at least in part on the indication identifying the set of subcarriers.

Aspect 18: The method of any of aspects 15 through 17, further comprising: receiving, from the UE, a UE capability message indicating a first capability of the UE to transmit the data message for DPoD processing at the network entity, a second capability of the UE to transmit a plurality of pilot signals distributed across the second set of frequency resources, or a combination thereof, wherein receiving the pilot signal is based at least in part on the UE capability message.

Aspect 19: The method of aspect 18, further comprising: transmitting, to the UE in response to the UE capability message, a configuration message configuring the UE to implement the first capability, the second capability, or a combination thereof, wherein receiving the pilot signal is further based at least in part on the configuration message.

Aspect 20: The method of any of aspects 15 through 19, wherein the set of subcarriers comprises all of the one of odd or even indexed subcarriers of the second set of frequency resources.

Aspect 21: The method of any of aspects 15 through 19, wherein the set of subcarriers comprises every fourth subcarrier within the second set of frequency resources.

Aspect 22: The method of any of aspects 15 through 19, further comprising: receiving, from a second UE, a second data message on a third set of frequency resources, wherein the third set of frequency resources overlaps at least a portion of the second set of frequency resources; and receiving, from the second UE, a second pilot signal associated with the second data message on a second set of subcarriers, wherein the second set of subcarriers comprises a different one of the odd or even indexed subcarriers within the third set of frequency resources, a first portion of the second set of subcarriers are within the first set of frequency resources, and a second portion of the second set of subcarriers are within the second set of frequency resources.

Aspect 23: The method of aspect 22, further comprising: receiving, from a third UE, a third data message on a fourth set of frequency resources, wherein the fourth set of frequency resources overlaps at least a portion of the second set of frequency resources, and is outside the third set of frequency resources; and receiving, from the third UE, a third pilot signal associated with the third data message on a third set of subcarriers, wherein the third set of subcarriers comprises the different one of the odd or even indexed subcarriers within the fourth set of frequency resources, a first portion of the third set of subcarriers are within the first set of frequency resources, and a second portion of the third set of subcarriers are within the second set of frequency resources.

Aspect 24: The method of any of aspects 15 through 23, wherein the first set of frequency resources comprises first frequency resources allocated for data communications of the first UE, and the second set of frequency resources comprises the first frequency resources allocated for data communications of the first UE and second frequency resources unallocated for the data communications of the first UE, the method further comprising: determining the second frequency resources for the UE based at least in part on an estimated non-linearity characteristic of the data message.

Aspect 25: The method of aspect 24, wherein determining the second frequency resources comprises: selecting the second frequency resources for the UE based at least in part on the estimated non-linearity characteristic satisfying an interference threshold for the second frequency resources for the UE.

Aspect 26: The method of any of aspects 15 through 25, wherein signaling associated with the data message comprises a non-linearity characteristic, the method further comprising: performing a DPoD technique on the data message and at least one other data message of a second UE; and decoding the data message and the at least one other data message based at least in part on performing the DPoD technique.

Aspect 27: The method of any of aspects 15 through 26, further comprising: performing channel estimation based at least in part on the pilot signal associated with the data message; and decoding the data message based at least in part on the channel estimation.

Aspect 28: The method of any of aspects 15 through 27, wherein the pilot signal comprises a DMRS.

Aspect 29: An apparatus for wireless communication at a UE, comprising a processor; and a memory coupled with the processor, wherein the memory comprises instructions executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprises instructions executable by a processor to perform a method of any of aspects 1 through 14.

Aspect 32: An apparatus for wireless communication at a network entity, comprising a processor; and a memory coupled with the processor, wherein the memory comprises instructions executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based at least in part on” shall not be construed as a reference to a closed set of conditions. For example, an example step that is described as “based at least in part on condition A” may be based at least in part on both a condition A and a condition B without departing from the scope of the present disclosure. In other words, as used herein, the phrase “based at least in part on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting a data message on a first set of frequency resources; and
transmitting a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

2. The method of claim 1, further comprising:
receiving, from a network entity, an indication of a set of one or more parameters for the UE to use to determine the pilot signal for the set of subcarriers based at least in part on the data message, wherein transmitting the pilot signal is based at least in part on the set of one or more parameters.

3. The method of claim 1, further comprising:
receiving, from a network entity, an indication identifying the set of subcarriers for the UE to use to transmit the pilot signal, wherein transmitting the pilot signal is based at least in part on the indication identifying the set of subcarriers.

4. The method of claim 1, further comprising:
transmitting, to a network entity, a UE capability message indicating a first capability of the UE to transmit the data message for digital post-distortion processing at the network entity, a second capability of the UE to transmit a plurality of pilot signals distributed across the second set of frequency resources, or a combination thereof, wherein transmitting the pilot signal outside the first set of frequency resources is based at least in part on the UE capability message.

5. The method of claim 4, further comprising:
receiving, from the network entity and in response to the UE capability message, a configuration message configuring the UE to implement the first capability, the second capability, or a combination thereof, wherein transmitting the pilot signal is further based at least in part on the configuration message.

6. The method of claim 1, wherein the set of subcarriers comprises all of the one of odd or even indexed subcarriers of the second set of frequency resources.

7. The method of claim 1, wherein the set of subcarriers comprises every fourth subcarrier within the second set of frequency resources.

8. The method of claim 1, wherein the first set of frequency resources further comprises a second set of subcarriers for a second pilot signal of a second UE that is associated with a data message of the second UE transmitted on frequency resources outside the first set of frequency resources, and the second set of subcarriers comprises a different one of the odd or even indexed subcarriers within a first portion of the first set of frequency resources.

9. The method of claim 8, wherein the first set of frequency resources further comprises a third set of subcarriers for a third pilot signal of a third UE that is associated with a data message of the third UE transmitted on frequency resources outside the first set of frequency resources, and the third set of subcarriers comprises the different one of the odd or even indexed subcarriers within a second portion of the first set of frequency resources different than the first portion.

10. The method of claim 1, wherein the first set of frequency resources comprises first frequency resources allocated for data communications of the first UE, and wherein the second set of frequency resources comprises the first frequency resources allocated for data communications of the first UE and second frequency resources unallocated for the data communications of the first UE, the method further comprising:
determining the second frequency resources based at least in part on an estimated non-linearity characteristic of the data message.

11. The method of claim 10, wherein determining the second frequency resources comprises:
selecting the second frequency resources based at least in part on the estimated non-linearity characteristic of the data message satisfying an interference threshold for the second frequency resources.

12. The method of claim 1, wherein the pilot signal comprises a demodulation reference signal.

13. The method of claim 1, further comprising:
aligning a first amplitude associated with a complementary cumulative distribution function of the pilot signal with a second amplitude associated with the complementary cumulative distribution function of the data message; and
transmitting the pilot signal based at least in part on the alignment.

14. The method of claim 13, wherein aligning the first amplitude with the second amplitude comprises:
selecting a first portion of resources of a set of resources for transmitting the pilot signal according to a polynomial generation technique; and
selecting a second portion of resources of the set of resources for transmitting the pilot signal sequentially based at least in part on a difference between the first amplitude associated with the complementary cumulative distribution function of the pilot signal and the second amplitude associated with the complementary cumulative distribution function of the data message, wherein the pilot signal is transmitted using the set of resources.

15. A method for wireless communication at a network entity, comprising:
receiving, from a user equipment (UE), a data message on a first set of frequency resources; and
receiving, from the UE, a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

16. The method of claim 15, further comprising:
transmitting, to the UE, an indication of a set of one or more parameters for the UE to use to determine the pilot signal for the set of subcarriers based at least in part on the data message, wherein receiving the pilot signal is based at least in part on the set of one or more parameters.

17. The method of claim 15, further comprising:
transmitting, to the UE, an indication identifying the set of subcarriers for the UE to use to transmit the pilot signal, wherein receiving the pilot signal is based at least in part on the indication identifying the set of subcarriers.

18. The method of claim 15, further comprising:
receiving, from the UE, a UE capability message indicating a first capability of the UE to transmit the data message for digital post-distortion processing at the network entity, a second capability of the UE to transmit a plurality of pilot signals distributed across the second set of frequency resources, or a combination thereof, wherein receiving the pilot signal is based at least in part on the UE capability message.

19. The method of claim 18, further comprising:
transmitting, to the UE in response to the UE capability message, a configuration message configuring the UE to implement the first capability, the second capability, or a combination thereof, wherein receiving the pilot signal is further based at least in part on the configuration message.

20. The method of claim 15, wherein the set of subcarriers comprises all of the one of odd or even indexed subcarriers of the second set of frequency resources.

21. The method of claim 15, wherein the set of subcarriers comprises every fourth subcarrier within the second set of frequency resources.

22. The method of claim 15, further comprising:
receiving, from a second UE, a second data message on a third set of frequency resources, wherein the third set of frequency resources overlaps at least a portion of the second set of frequency resources; and
receiving, from the second UE, a second pilot signal associated with the second data message on a second set of subcarriers, wherein the second set of subcarriers comprises a different one of the odd or even indexed subcarriers within the third set of frequency resources, a first portion of the second set of subcarriers are within the first set of frequency resources, and a second portion of the second set of subcarriers are within the second set of frequency resources.

23. The method of claim 22, further comprising:
receiving, from a third UE, a third data message on a fourth set of frequency resources, wherein the fourth set of frequency resources overlaps at least a portion of the second set of frequency resources, and is outside the third set of frequency resources; and
receiving, from the third UE, a third pilot signal associated with the third data message on a third set of subcarriers, wherein the third set of subcarriers comprises the different one of the odd or even indexed subcarriers within the fourth set of frequency resources, a first portion of the third set of subcarriers are within the first set of frequency resources, and a second portion of the third set of subcarriers are within the second set of frequency resources.

24. The method of claim 15, wherein the first set of frequency resources comprises first frequency resources allocated for data communications of the first UE, and the second set of frequency resources comprises the first frequency resources allocated for data communications of the first UE and second frequency resources unallocated for the data communications of the first UE, the method further comprising:
determining the second frequency resources for the UE based at least in part on an estimated non-linearity characteristic of the data message.

25. The method of claim 24, wherein determining the second frequency resources comprises:
selecting the second frequency resources for the UE based at least in part on the estimated non-linearity characteristic satisfying an interference threshold for the second frequency resources for the UE.

26. The method of claim 15, wherein signaling associated with the data message comprises a non-linearity characteristic, the method further comprising:
performing a digital post-distortion technique on the data message and at least one other data message of a second UE; and
decoding the data message and the at least one other data message based at least in part on performing the digital post-distortion technique.

27. The method of claim 15, further comprising:
performing channel estimation based at least in part on the pilot signal associated with the data message; and
decoding the data message based at least in part on the channel estimation.

28. The method of claim 15, wherein the pilot signal comprises a demodulation reference signal.

29. An apparatus for wireless communication at a user equipment (UE), comprising:
a processor; and
a memory coupled with the processor, wherein the memory comprises instructions executable by the processor to cause the apparatus to:
transmit a data message on a first set of frequency resources; and
transmit a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.

30. An apparatus for wireless communication at a network entity, comprising:
a processor; and
a memory coupled with the processor, wherein the memory comprises instructions executable by the processor to cause the apparatus to:
receive, from a user equipment (UE), a data message on a first set of frequency resources; and
receive, from the UE, a pilot signal associated with the data message on a set of subcarriers within a second set of frequency resources, wherein the first set of frequency resources is a subset of the second set of frequency resources, the set of subcarriers comprises one of odd or even indexed subcarriers within the second set of frequency resources, at least a first portion of the set of subcarriers are within the first set of frequency resources, and at least a second portion of the set of subcarriers are within the second set of frequency resources and outside the first set of frequency resources.
